(19) United States
(12) Patent Application Publication
(10) Pub. No.: US 2026/0222369 A1
(43) Pub. Date: Jul. 30, 2026

(54) VECTOR-BASED HYBRID SEARCH FOR CHATBOTS

(71) Applicant: ADP, Inc., Roseland, NJ (US)

(72) Inventors: Rajarajeswari Balasubramaniyan, Dunwoody, GA (US); Kumar Shivam, Alpharetta, GA (US); Jongsung Eo, Peachtree Corners, GA (US); Samhitha Balla, Alpharetta, GA (US); Dimitry Plotko, Roswell, GA (US); Sri Manikanth Nunna, Alpharetta, GA (US); Jashwanthreddy Katamreddy, Nellore (IN)

(73) Assignee: ADP, Inc., Roseland, NJ (US)

(21) Appl. No.: 19/182,358

(22) Filed: Apr. 17, 2025

(30) Foreign Application Priority Data
Jan. 30, 2025 (IN) 202511007734

(51) Int. Cl. H04L 51/02

(52) U.S. Cl. CPC H04L 51/02

(57) ABSTRACT

Vector-based hybrid search for chatbots is provided. A system receives, via a chatbot, a user query. The system generates, using an artificial intelligence model, a vector representation based on a combination of the user query, historical queries, and corresponding responses and identify a cached response corresponding to the user query in a semantic cache using the vector representation. The system executes, based on the cached response, a hybrid search operation including retrieval of first and second results having a first and second accuracy value by execution of a first and second search process on a first and second data source. The system selects one of the first or the second results based on modeling the first and the second accuracy value and displays, responsive to the user query, an output corresponding to the selected results.

### CROSS-REFERENCE TO RELATED PATENT APPLICATIONS

This application claims the benefit of and priority to Indian Provisional Patent Application No. 202511007734, filed Jan. 30, 2025, the entirety of which is incorporated by reference herein.

### TECHNICAL FIELD

This disclosure is directed to computing technology and, particularly, to a chatbot constructing responses to queries using vector-based hybrid search.

### BACKGROUND

A chatbot can be used to receive user queries and output responses. However, chatbot responses may be inaccurate or erroneous.

### SUMMARY

Technical solutions disclosed herein assist service orchestration using vector-based hybrid search for chatbots. Technical challenges when developing and implementing chatbots are that automatically generated responses by such chatbots to user queries can include various errors or inaccuracies. The technical solutions described herein address such technical challenges and reduce errors and inaccuracies in chatbot responses. The technical solutions described herein address such technical challenges by executing multiple search operations (e.g., a semantic search operation of a semantic cache and a hybrid search operation of multiple data sources using a vector representation) and selecting one or more results of the search operations based on one or more corresponding accuracy values. However, although verifying the accuracy of chatbot responses before providing the responses to a user can improve accuracy, such verifications can also increase processing loads and slow chatbot response times. Technical solutions described herein facilitate efficient verifications, with comparatively reduced processing loads for the verification of chatbot responses. The technical solutions described herein facilitate using an artificial intelligence (AI) model to generate an improved search input (e.g., the vector representation) for search operations, which further improve (reduce) response times. For example, technical solutions described herein generate the vector representation based on a received user query and a chat history (e.g., historical queries and corresponding responses), which is used in search operations. Such use of vector representation provides contextually relevant and accurate search results by incorporating prior interactions and dynamically adapting to user intent. Further, the technical solutions described herein improve the processing speed of chatbots and reduce processing loads. Such technical improvements are facilitated by implementing a semantic cache. Additionally, or alternatively, the technical improvements are facilitated by automatically querying internal sources to extract and store verified data in one or more data sources used in search operations. The semantic cache can be dynamically queried for verified and accurate responses in some examples.

An aspect of this technical solution is directed to a system. The system can include one or more processors, coupled with memory. The one or more processors can receive, via a chatbot, a user query. The one or more processors can generate, using an artificial intelligence model, a vector representation based on a combination of the user query, one or more historical queries, and one or more responses corresponding to the one or more historical queries. The one or more processors can identify a cached response corresponding to the user query in a semantic cache by execution of a semantic search operation using the vector representation. The one or more processors can execute, based on the cached response, a hybrid search operation associated with the user query. The hybrid search operation can include retrieval of first results having a first accuracy value by execution of a first search process of the hybrid search operation on a first data source using the vector representation. The hybrid search operation can include retrieval of second results having a second accuracy value by execution of a second search process of the hybrid search operation on a second data source using data corresponding to the vector representation. The one or more processors can select one of the first results or the second results based on modeling the first accuracy value and the second accuracy value. The one or more processors can display, responsive to the user query, an output corresponding to the selected one of the first results or the second results.

In some aspects, the techniques described herein relate to a system, wherein the one or more processors further generate an index including a plurality of vector representations of content based on scanning a plurality of documents. The one or more processors can determine one or more scores representing similarities between the plurality of vector representations of the content and the vector representation. The one or more processors can provide the first results including data of the plurality of documents in response to determining at least one score of the one or more scores satisfies at least one threshold corresponding to the first accuracy value.

In some aspects, the techniques described herein relate to a system, wherein the one or more processors further issue one or more automated requests to a plurality of internal sources including verified content. The one or more processors can generate a plurality of vector representations corresponding to verified data extracted from the verified content. The one or more processors can store the plurality of vector representations in an index accessible to the first data source.

In some aspects, the techniques described herein relate to a system, wherein the second data source includes at least one knowledge graph including a plurality of nodes and edges connecting the plurality of nodes, and wherein the data corresponding to the vector representation includes a structured query corresponding to a schema of the at least one knowledge graph.

In some aspects, the techniques described herein relate to a system, wherein the one or more processors further map one or more portions of the vector representation to at least one node type, node attribute, or edge type corresponding to the plurality of nodes and edges based on the schema. The one or more processors can generate the structured query including the at least one node type, node attribute, or edge type.

In some aspects, the techniques described herein relate to a system, wherein the one or more processors further identify, using the artificial intelligence model, a subject of the user query corresponding to at least one location. The one or more processors can determine, using the artificial intelligence model, the at least one location corresponds to multiple locations or is incomplete. The one or more processors can disambiguate the at least one location by execution of one or more computer-executable instructions. The one or more processors can receive, responsive to the disambiguation, a plurality of candidate locations corresponding to the at least one location.

In some aspects, the techniques described herein relate to a system, wherein the one or more processors further determine, using the artificial intelligence model, the plurality of candidate locations are dissociated with the subject. The one or more processors can provide, via the chatbot, a prompt including one or more location queries corresponding to the at least one location, the multiple locations, or the plurality of candidate locations. The one or more processors can receive, via the chatbot, an input responsive to the prompt. The one or more processors can update the subject of the user query based on the input.

In some aspects, the techniques described herein relate to a system, wherein the one or more processors further determine to execute the hybrid search operation based on determining that the cached response fails to satisfy at least one threshold.

In some aspects, the techniques described herein relate to a system, wherein the one or more processors further categorize the user query in a query category based on a predefined taxonomy of query types. The one or more processors can select search parameters for the hybrid search operation based on the query category.

In some aspects, the techniques described herein relate to a system, wherein the one or more processors further aggregate the first results and the second results to generate aggregated results. The one or more processors can rank the aggregated results based on at least one of the first accuracy value, the second accuracy value, or a third accuracy value generated by the artificial intelligence model. The one or more processors can select, using the artificial intelligence model, a subset of the aggregated results satisfying at least one threshold. The one or more processors can display, using the chatbot, the output including the subset in response to the user query.

In some aspects, the techniques described herein relate to a system, wherein the one or more processors further determine the first accuracy value and the second accuracy value based on a subject of the user query. The one or more processors can adjust the first accuracy value or the second accuracy value in response to receiving a new query.

In some aspects, the techniques described herein relate to a system, wherein the one or more processors further determine the first results failing the first accuracy value and the second results failing the second accuracy value. The one or more processors can initiate a third search of one or more third data sources, the one or more third data sources corresponding to a plurality of external links which direct to a plurality of external content.

In some aspects, the techniques described herein relate to a system, wherein the one or more processors further retrieve one or more links of the plurality of external links relevant to the user query based on a content relevance score associated with the plurality of external content. The one or more processors can provide a prompt including the one or more links via the chatbot in response to the user query.

An aspect of this technical solution is directed to a method. The method can include receiving, by one or more processors coupled with memory, via a chatbot, a user query. The method can include generating, by the one or more processors, using an artificial intelligence model, a vector representation based on a combination of the user query, one or more historical queries, and one or more responses corresponding to the one or more historical queries. The method can include identifying, by the one or more processors, a cached response corresponding to the user query in a semantic cache by execution of a semantic cache operation using the vector representation. The method can include executing, by the one or more processors, based on the cached response, a hybrid search operation associated with the user query. The hybrid search operation can include retrieving, by the one or more processors, first results having a first accuracy value by execution of a first search process of the hybrid search operation on a first data source using the vector representation. The hybrid search operation can include retrieving, by the one or more processors, second results having a second accuracy value by execution of a second search process of the hybrid search operation on a second data source using data corresponding to the vector representation. The method can include selecting, by the one or more processors, one of the first results or the second results based on modeling the first accuracy value and the second accuracy value. The method can include displaying, by the one or more processors, responsive to the user query, an output corresponding to the selected one of the first results or the second results.

In some aspects, the techniques described herein relate to a method, further including generating, by the one or more processors, an index including a plurality of vector representations of content based on scanning a plurality of documents. The method can include determining, by the one or more processors, one or more scores representing similarities between the plurality of vector representations of the content and the vector representation. The method can include providing, by the one or more processors, the first results including data of the plurality of documents in response to determining at least one score of the one or more scores satisfies at least one threshold corresponding to the first accuracy value.

In some aspects, the techniques described herein relate to a method, further including issuing, by the one or more processors, one or more automated requests to a plurality of internal sources including verified content. The method can include generating, by the one or more processors, a second plurality of vector representations corresponding to verified data extracted from the verified content. The method can include storing, by the one or more processors, the second plurality of vector representations in an index accessible to the first data source.

In some aspects, the techniques described herein relate to a method, wherein the second data source includes at least one knowledge graph including a plurality of nodes and edges connecting the plurality of nodes, and wherein the data corresponding to the vector representation includes a structured query corresponding to a schema of the at least one knowledge graph.

In some aspects, the techniques described herein relate to a method, further including mapping, by the one or more processors, one or more portions of the vector representation to at least one node type, node attribute, or edge type corresponding to the plurality of nodes and edges based on the schema. The method can include generating, by the one or more processors, the structured query including the at least one node type, node attribute, or edge type.

In some aspects, the techniques described herein relate to a method, further including identifying, by the one or more processors, using the artificial intelligence model, a subject of the user query corresponding to at least one location. The method can include determining, by the one or more processors, using the artificial intelligence model, the at least one location corresponds to multiple locations or is incomplete. The method can include disambiguating, by the one or more processors, the at least one location by execution of one or more computer-executable instructions. The method can include receiving, by the one or more processors, responsive to the disambiguation, a plurality of candidate locations corresponding to the at least one location.

In some aspects, the techniques described herein relate to a non-transitory computer-readable storage device having instructions stored thereon on that, when executed by one or more processors, cause the one or more processors to receive, via a chatbot, a user query. The instruction can cause the one or more processors to generate, using an artificial intelligence model, a vector representation based on a combination of the user query, one or more historical queries, and one or more responses corresponding to the one or more historical queries. The instruction can cause the one or more processors to identify a cached response corresponding to the user query in a semantic cache by execution of a semantic search operation using the vector representation. The instruction can cause the one or more processors to execute, based on the cached response, a hybrid search operation associated with the user query. The hybrid search operation can include retrieval of first results having a first accuracy value by execution of a first search process of the hybrid search operation on a first data source using the vector representation. The hybrid search operation can include retrieval of second results having a second accuracy value by execution of a second search process of the hybrid search operation on a second data source using data corresponding to the vector representation. The instruction can cause the one or more processors to select one of the first results or the second results based on modeling the first accuracy value and the second accuracy value. The instruction can cause the one or more processors to display, responsive to the user query, an output corresponding to the selected one of the first results or the second results.

These and other aspects and implementations are discussed in detail below. The foregoing information and the following detailed description include illustrative examples of various aspects and implementations and provide an overview or framework for understanding the nature and character of the claimed aspects and implementations. The drawings provide illustrations and a further understanding of the various aspects and implementations and are incorporated in and constitute a part of this specification. The foregoing information and the following detailed description and drawings include illustrative examples and should not be considered as limiting.

### BRIEF DESCRIPTION OF THE FIGURES

Aspects of the present disclosure are described in the detailed description which follows, in reference to the noted plurality of drawings by way of non-limiting examples of exemplary embodiments of the technical solutions described herein.

FIG. 1 is an illustrative example of a system for vector-based hybrid search for chatbots, in accordance with some implementations;

FIGS. 2A-2B depict illustrative examples of computer-implemented methods for vector-based hybrid search for chatbots, in accordance with some implementations.

FIG. 3 is an illustrative example of a system for vector-based hybrid search for chatbots, in accordance with some implementations;

FIGS. 4A-4D depict an illustrative example of a process for vector-based hybrid search for chatbots, in accordance with some implementations.

FIG. 5 is an illustrative example of a computer-implemented method for updating data used in a vector-based hybrid search, in accordance with some implementations.

FIG. 6 is an illustrative example of a computer-implemented method for updating data used in a vector-based hybrid search, in accordance with some implementations.

FIG. 7 is an illustrative example of a computer-implemented search method that can be used in a vector-based hybrid search, in accordance with some implementations.

FIG. 8 depicts an illustrative architecture of a computing system implemented in some implementations of the present disclosure.

### DETAILED DESCRIPTION

Following below are more detailed descriptions of various concepts related to, and implementations of, systems, methods, or non-transitory computer-readable storage media (CRM) for assist service orchestration. The various concepts introduced above or discussed in greater detail below can be implemented in any of numerous ways.

Aspects of technical solutions disclosed herein relate to vector-based hybrid search for chatbots. In some aspects, a chatbot can receive a user query. For example, the user query can correspond to a subject, such as a minimum wage in a geographic location. The technical solutions described herein can generate a vector representation used in various search operations to retrieve accurate results corresponding to the user query. For example, the technology can use a generative artificial intelligence model to generate the vector representation based on a combination of the user query, one or more historical queries, and one or more corresponding responses (e.g., from a chat history). The technical solutions described herein can execute a search of a semantic cache using the vector representation to identify a cached response corresponding with the user query. In some aspects, if the cached response does not meet predefined criteria, the technical solutions described herein can execute a hybrid search operation using the vector representation. In some aspects, the hybrid search operation can include executing a first search operation using a first data source (e.g., search or analytics engine) and second search operation using a second data source (e.g., a structured database or knowledge graph). The technical solutions described herein can select one or more results retrieved from the hybrid search based on corresponding accuracy values and display the selected results as a response to the user query via the chatbot.

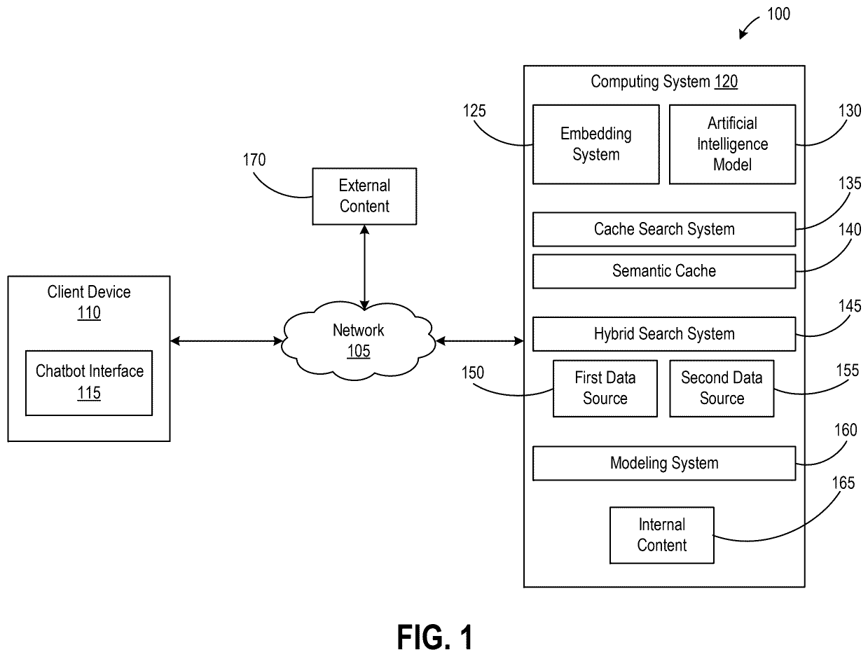

FIG. 1 is an illustrative example of system 100 for vector-based hybrid search for chatbots. The system 100 can include a computing system 120 that communicates or otherwise interfaces with a client device 110 via a network 105. The computing system 120 can communicate or otherwise interface with the client device 110 via the network 105 to receive user queries and provide corresponding responses via a chatbot interface 115. The computing system 120 can include one or more of an embedding system 125 or an AI model 130 for generating search inputs used for search operations or generating responses to user queries. The computing system 120 can include one or more sub-systems for executing various search operations, including, for example, a cache search system 135, a semantic cache 140, a hybrid search system 145, a first data source 150, and a second data source 155. The computing system 120 can include a modeling system 160 for selecting and modeling search results to provide as a response to a user query. The system 100 can include internal data objects 165 and external data objects 170 accessible by the client device 110, computing system 120, and sub-systems of the computing system 120.

Although the components of FIG. 1 can be described in the singular form herein (e.g., a client device 110, computing system 120, etc.), it should be understood that the system 100 can include two or more of any components (e.g., two client devices 110, etc.). Each of the components or subsystems of system 100 (e.g., client device 110, computing system 120, embedding system 125, AI model 130, cache search system 135, semantic cache 140, hybrid search system 145, first data source 150, second data source 155, modeling system 160, etc.) can include one or more processors coupled with memory or software and capable of performing the various processes and tasks described herein, such as executing search operations or providing responses to user queries. In some aspects, one or more of the sub-systems of the computing system 120 (e.g., embedding system 125, AI model 130, cache search system 135, semantic cache 140, hybrid search system 145, first data source 150, second data source 155, modeling system 160, etc.) can be local to or remote from the computing system 120.

The network 105 can include a wireless or wired connection for enabling the client device 110 or the computing system 120 to store, transmit, receive, or display information for dynamic assist service orchestration. The network 105 facilitates the client device 110 or the computing system 120 communicating with internal subcomponents (described herein) or external components. The computing system 120, for example, receives data from the client device 110 and transmits data to the client device 110 via the network 105. For example, computing system 120 can receive a user query, one or more historical queries, and one or more corresponding responses via the chatbot interface 115. The network 105 can include a hardwired connection (e.g., copper wire or fiber optics) or a wireless connection (e.g., wide area network (WAN), controller area network (CAN), local area network (LAN), or personal area network (PAN)). For example, the network 105 can support Wi-Fi, Bluetooth, BLE, or other communication protocols for transferring data. In some aspects, one or more components of FIG. 1 (e.g., client device 110, computing system 120) use network 105 to perform the various processes and tasks described herein (e.g., executing search operations, providing responses to user queries, etc.).

The network 105 can facilitate communications in accordance with various communication protocols such as Transmission Control Protocol and Internet Protocol (TCP/IP), User Datagram Protocol (UDP), or IEEE communication protocols. In one example, the network 105 can include wireless communications according to Bluetooth specification sets, or another standard or proprietary wireless communication protocol. In another example, the network 105 can also include communications over a cellular network, including, e.g., a GSM (Global System for Mobile Communications), CDMA (Code Division Multiple Access), EDGE (Enhanced Data for Global Evolution) network.

The systems or sub-systems described herein with regard to FIG. 1 (e.g., client device 110, computing system 120, embedding system 125, AI model 130, cache search system 135, semantic cache 140, hybrid search system 145, first data source 150, second data source 155, modeling system 160, etc.) can include any combination of hardware and software. For example, client device 110, computing system 120, embedding system 125, AI model 130, cache search system 135, semantic cache 140, hybrid search system 145, first data source 150, second data source 155, modeling system 160, etc. can include any computing device including one or more processors coupled with memory or software and capable of performing the various processes and tasks described herein.

The client device 110 can include a laptop, a desktop computer, a smart phone, a tablet, etc. In some aspects, the client device 110 can be operated by or associated with a user or client. The client device 110 can execute various applications including any platform for performing various tasks or operations, such as a low-code platform, no-code platform, software-as-a-service platform (SaaS), web application, web browser, desktop application, or others. For example, the client device 110 can execute chatbot interface 115 to receive queries and display responses. In some aspects, the client device 110 can receive, via chatbot interface 115, a user query. In some aspects, the client device 110 can include various input or output devices (e.g., an input/output circuit, a pointing device, a keyboard, a display, a touch screen, a microphone, a speaker, etc.). For example, the client device 110 can receive a query via a user interaction with an input element (e.g., keyboard, microphone, touch screen, etc.). In response to receiving the user query, the client device 110 can transmit data corresponding to the user query to the computing system 120, receive one or more responses corresponding to the user query identified by the computing system 120, and display data corresponding to one or more responses via an output element (e.g., screen or speaker of the client device 110).

The chatbot interface 115 can include or refer to any data processing system that can receive an input and provide or display an output. An input may include or refer to a user query transmitted or inputted to the chatbot interface 115. An output may include or refer to a prompt or response to a user query provided via the chatbot interface 115. The chatbot interface 115 can include one or more interfaces. For example, the chatbot interface 115 can refer to or include one or more graphical user interfaces (GUIs), text-based interfaces (e.g., messaging app, chat window in a web application, etc.), voice-based interfaces (e.g., virtual assistant on a smart device), or multimodal interfaces (e.g., interface combining text, voice, or other inputs and outputs to facilitate user interaction). The chatbot interface 115 can display various information (e.g., images, text-based information, prompts, etc.) or interactive elements (e.g., user input fields, buttons, menus, etc.) via client device 110 (e.g., using the GUI). For example, the chatbot interface 115 or client device 110 can display, responsive to a user query, an output corresponding to selected results of a hybrid search process. The client device 110 can dynamically update the arrangement of information or elements of chatbot interface 115 in response to various conditions or received data. The chatbot interface 115 can include various artificial intelligence functionalities or interface with an artificial intelligence model (e.g., AI model 130, an LLM, etc.), as further described herein.

The chatbot interface 115 can receive a user query. For example, the chatbot interface 115 can receive a query in the form of user input via the client device 110. Receiving user input can include determining that a query is inputted into a text input field or a corresponding user input element (e.g., “enter” or “submit” button, etc.) is selected. The chatbot interface 115 can provide responses or prompts. For example, the chatbot interface 115 can provide a prompt in response to a user query via an output device. The chatbot interface 115 can receive a response to a prompt. For example, the chatbot interface 115 can transmit a prompt including one or more locations corresponding to a user query and receive an input responsive to the prompt (e.g., selecting at least one of the one or more locations). The chatbot interface 115 can execute various processes based on receiving an input. For example, the chatbot interface 115 can update a subject of a user query based on input received via an interface.

The computing system 120 can provide assist service orchestration using a vector-based hybrid search. For example, the computing system 120 can include a laptop, desktop computer, smart phone, tablet, server, database, etc., or can include a collection of such devices. The computing system 120 can include a communications unit configured to facilitate communications, or otherwise interface with, one or more components of the computing system 120 or the system 100. For example, the computing system 120 can receive data (e.g., a user query) from client device 110 and provide data (e.g., a prompt or response) to the client device 110 in response to a user query. The computing system 120 can correspond with an organization or can be used to perform or execute various processes associated with an organization. The computing system 120 can include subsystems or subcomponents, such as embedding system 125, AI model 130, cache search system 135, semantic cache 140, hybrid search system 145, first data source 150, second data source 155, or modeling system 160.

The embedding system 125 can receive a user query. For example, the embedding system 125 can receive the user query via a chatbot interface 115. The embedding system 125 can receive a user query from the client device 110 via the computing system 120 and generate a vector representation corresponding to the user query. The vector representation of the user query can refer to or include a model of the user query. For example, a vector representation can refer to an embedding or numerical representation. A vector representation of a user query can refer to an embedding of one or more portions of a user query mapped to a multidimensional space. To generate the vector representation, the embedding system 125 can execute one or more embedding algorithms or models. For example, the embedding system 125 can use an embedding algorithm, such as Word2Vec, GloVe, or BERT, to generate vector representations of user queries. The embedding system 125, using an embedding algorithm, can transform textual data into dense vectors within a multidimensional space, capturing the semantic meaning and relationships between words. The resulting vectors allow the computing system 120 to efficiently process and retrieve information by positioning semantically similar queries closer together.

The embedding algorithms or models can analyze elements of the user query, such as linguistic elements, semantic elements, or contextual elements of the user query. For example, linguistic elements can refer to or include grammatical structures, word forms, syntax, or parts of speech in the user query. Semantic elements can refer to or include meanings of words, phrases, or an intent (e.g., subject) conveyed by the user query. Contextual elements can refer to or include historical interactions (e.g., chat history), user preferences, or an environment or context in which the query is made.

Upon, responsive to, or subsequent to executing the embedding algorithms to analyze the elements of the user query, the embedding system 125 can map the analyzed elements to a multidimensional vector space in order to generate the vector representation. The multidimensional vector space can include one or more dimensions. Each dimension of the multidimensional vector space can include or represent a contextual or feature-based attribute of the user query. For example, contextual or feature-based attributes of the user query can refer linguistic elements, semantic elements, or contextual elements of the user query, such as grammatical structures of the user query, syntax, parts of speech, sentence types, morphological features, punctuation patterns, word meanings, relationships between entities, named entities, sentiment, intent, topic classification, polarity detection, temporal and spatial context, user history, device type, session state, metadata, and so on. For example, the vector space can include dimensions representing attributes or elements including geographic location (e.g., state, city, or region), legal domain (e.g., wage regulations, employment statutes), or temporal context (e.g., current laws, historical precedents) corresponding with a user query.

The embedding system 125 can generate a vector representation based on the user query, one or more historical queries, and one or more historical responses corresponding to the one or more historical queries. For example, the embedding system 125 analyzes a chat history of chatbot interface 115 to generate a vector representation. Analyzing the chat history can include extracting linguistic, semantic, or contextual elements from past queries or responses, summarizing prior interactions, identifying recurring topics or patterns, or determining a subject or context of a chatbot conversation. For example, the embedding system 125 can generate a single or standalone query based on condensing a chat history and received user query and embedding the condensed data as a vector. As described further herein, the embedding system 125 can interface with the artificial intelligence model 130 to generate the vector representation of the user query.

The artificial intelligence (AI) model 130 can include any machine learning (ML) or AI model that generates content or new content, such as text, images, or code, by learning patterns and structures from existing data. For example, the AI model 130 can include a model, a computational system, or an algorithm that can learn patterns from data (e.g., chunks of data from various input documents, computer code, templates, forms, etc.) and make predictions or perform tasks without being explicitly programmed to perform such tasks.

In some aspects, the AI model 130 can refer to or include an ML model that has been trained using machine learning to perform a task, such as classification, regression, or clustering. Examples of ML training techniques can include, for example, decision trees, neural networks, or support vector machines. In some aspects, the AI model 130 can refer to or include a large language model (LLM), a neural network, or any type of artificial intelligence. A large language model (LLM) can include or refer to a neural network-based model with a parameter count (e.g., number of adjustable weights) substantially equivalent to or exceeding 100 billion parameters and trained on vast and heterogeneous datasets (e.g., collections of text from books, articles, web pages, etc.) to perform a range of tasks, including text generation, contextual question answering, and language analysis across diverse domains. The AI model 130 can also include or refer to small or medium-sized models (e.g., models with less than 100 billion parameters and/or trained for delimited tasks) or collections of such models. For example, the AI model 130 can include or refer to a collection or suite of rule-based systems and machine learning models used to perform domain-based tasks, including natural language processing, document analysis, or enterprise data interpretation.

In some examples, the AI model 130 can include, refer to, or otherwise utilize or access a retrieval-augmented generation (RAG) system. For example, the AI model 130 can be designed, constructed, or include a transformer architecture with one or more of a self-attention mechanism (e.g., model used to weigh the importance of different words or tokens in a sentence when encoding a word at a particular position), positional encoding, or encoder and decoder layers (e.g., multiple layers containing multi-head self-attention mechanisms and feedforward neural networks). Transformer architecture can include, for example, a generative pre-trained transformer, a bidirectional encoder representations from transformers (BERT), a transformer-XL (e.g., using recurrence to capture longer-term dependencies beyond a fixed-length context window), a text-to-text transfer transformer, etc.

The AI model 130 can be trained using a dataset of documents (e.g., web pages or content, text, images, videos, audio, or other data) and can be designed to understand and extract relevant information from the dataset. The AI model 130 can be trained (e.g., by a model training function) using any text-based dataset by converting the text data from the input dataset documents into numerical representations (e.g., embeddings) of the chunks of the documents. In some aspects, the artificial intelligence model 130 can be generated or built using deep learning techniques, such as neural networks. Through training, the AI model 130 can adjust various internal parameters, such as relationships between embeddings or numerical values learned during training, to optimize performance and improve the accuracy of outputs or predictions. In some aspects, adjusting internal parameters can include iteratively presenting embeddings of dataset chunks to the AI model 130, comparing outputs of the AI model 130 to verified or known results, and updating parameters (e.g., modifying weight matrices, recalibrating biases, or fine-tuning activation thresholds of the AI model 130) based on results of the comparison. By iteratively learning from the dataset embeddings, the AI model 130 can generalize knowledge and generate accurate predictions or relevant insights when processing prompts (e.g., user queries, requests, etc.).

The AI model 130 can generate a vector representation of a query. For example, the AI model 130 can generate a vector representation by executing one or more natural language processing techniques or algorithms, pattern recognition techniques, embedding techniques, or artificial intelligence techniques. Executing natural language processing techniques or algorithms, pattern recognition techniques, embedding techniques, or artificial intelligence techniques can include determining a subject or intent of a user query, summarizing queries or responses, extracting entities or relationships, identifying a context or subject, or classifying a query into one or more categories. The AI model 130 can generate the vector representation used based on the user query, one or more historical queries, and one or more historical responses corresponding to the one or more historical queries. For example, the AI model 130 can execute one or more natural language processing algorithms to summarize the user query, historical queries, and historical responses into standalone queries. For example, the AI model 130 can execute one or more embedding algorithms to map tokens, phrases, and relationships included in a query or chat history into a multidimensional vector space. The AI model 130 can provide the vector representation to various systems or sub-systems of FIG. 1 (e.g., cache search system 135) for use in one or more search operations, as further described herein.

The cache search system 135 can execute a cache search operation. For example, the cache search system 135 can include any combination of hardware or software to execute a semantic search operation on the semantic cache 140. A semantic search operation may include or refer to retrieving, ranking, matching, or selecting data objects in a cached based on elements or subjects corresponding with a provided input. For example, executing a semantic search operation can include providing the vector representation generated by embedding system 125 or AI model 130 as an input or search parameter to the semantic cache 140. Upon, responsive to, or subsequent to providing the vector representation, the cache search system 135 can receive an output from the semantic cache 140. The output can include search results or data objects. For example, the cache search system 135 can receive search results (e.g., a cached response) corresponding with the vector representation provided to the semantic cache 140 in response to executing the semantic search operation.

The semantic cache 140 can include any combination hardware or software for storing data objects corresponding to a user query. In some aspects, information in the semantic cache 140 is stored using any type of memory, such as a cloud or hard drive. The semantic cache 140 includes, for example, random access memory (RAM), dynamic random access memory (DRAM), static random access memory (SRAM), error-correcting code (ECC), read only memory (ROM), programmable read only memory (PROM), or electrically erasable read only memory (EEPROM). The information or data structures (e.g., scanned documents, digital content, records, tables, lists, or spreadsheets) contained within semantic cache 140 can be dynamic and change periodically (e.g., daily or by milliseconds); via an input from a user (e.g., a user operating the client device 110); via inputs from various components of the system 100 (e.g., computing system 120) and sub-systems of the computing system 120 (e.g., first data source 150), or via an external update to the system 100.

The semantic cache 140 can store queries or responses. For example, the semantic cache 140 can store a plurality of cached queries and corresponding cached responses as vector representations. Each vector representation of a cached query can correspond with a vector representation of a corresponding cached response. That is, the semantic cache 140 can store pairs of cached queries mapped to corresponding responses (e.g., Q&A pairs). The semantic cache 140 can execute a semantic search operation. For example, executing a semantic search operation can include analyzing a vector representation provided as search input by the cache search system 135. For example, executing a semantic search operation can include comparing a vector representation of a user query to stored vector representations of cached queries in the semantic cache 140. Comparing can include determining similarity scores, distances in a multi-dimensional vector space, or other metrics to identify a cached query that matches or corresponds with the received vector representation.

Upon, responsive to, or subsequent to identifying a cached query, the semantic cache 140 can determine the user query matches or does not match at least one of the plurality of cached queries. Determining the user query matches or does not match a cached query can include determining one or more accuracy values or relevance scores corresponding to the user query and the cached queries. The accuracy values or relevance scores can include or refer to similarity metrics (e.g., cosine similarity, Euclidean distance, other vector space measures) to evaluate or compare the vector representation of the user query and the vector representations of the cached queries based on linguistic, semantic, or contextual elements (e.g., frequency of terms, semantic overlap, patterns, etc.). Using the accuracy values or relevant scores, the semantic cache 140 can determine if a cached response matches the user query. Upon, responsive to, or subsequent to determining a matching cached query, the semantic cache 140 can retrieve the corresponding cached response. Upon, responsive to, or subsequent to failing to determine a matching cache query, the semantic cache 140 can return a notification or initiate a hybrid search, as described below.

The hybrid search system 145 can execute one or more search operations. For example, the hybrid search system 145 can include any combination of hardware or software for executing a hybrid search operation associated with the user query. That is, upon, responsive to, or subsequent to determining that the semantic cache 140 does not contain a cached query sufficiently matching the user query, the hybrid search system 145 can execute a hybrid search operation to retrieve results associated with the user query. The hybrid search operation can include a first search process and a second search process. The first search process of the hybrid search operation can include or refer to a search of the first data source 150. The second search process of the hybrid search operation can include or refer to a search of the second data source 155. As described further below, searching the first data source 150 and second data source 155 can include searching various repositories, querying structured databases or knowledge graphs, and accessing document stores or data streams to retrieve results corresponding with the user query.

The first data source 150 can include or refer to any data source or repository. The first data source can include or refer to a vector database. The first data source 150 can include a distributed search index that stores, manages, and retrieves results or data objects based on received search queries. For example, the first data source 150 can include a document-based search engine that indexes and queries unstructured data from sources such as web pages, textual content, documents, or other data objects. For example, the first data source 150 can search or query internal data objects 165 or external data objects 170 in executing the first search process using a search input. For example, the first data source 150 can provide a vector representation as a search input for the hybrid search process.

The first data source 150 can retrieve first results corresponding with the data searched during the first search operation. For example, retrieving first results can include receiving a vector representation as a search input and identifying one or more stored data objects corresponding with the search input. Identifying one or more data objects can include comparing the vector representation to stored data representations of the first data source 150. For example, the first data source 150 can use embedding-based search techniques to analyze the received vector representation by comparing the vector representation to indexed data objects stored within an index of the first data source 150. The comparison can include evaluating one or more accuracy values. For example, the first results can have or be associated with an accuracy value. The accuracy value can include or refer to metrics associated with a relevance or confidence of the identified data objects in relation to the search input. For example, the first data source 150 can calculate accuracy values, determine similarity scores, or measure cosine distances in a vector space to identify vector representations of data objects that correspond with the user query.

The second data source 155 can include or refer to any data source, database, or repository. For example, the second data source 155 can include a knowledge graph. A knowledge graph can include or refer to a graph database that stores data as a plurality of interconnected nodes and represents relationships between the nodes using links or edges. The second data source 155 can include any combination of hardware and software configured to store and retrieve results or semantic relationships between data points, such as concepts, entities, and attributes. The second data source 155 can search or query internal data objects 165 or external data objects 170 in executing the second search process using a search input. For example, the second data source 155 can receive a structured query (e.g., cipher query) corresponding to a vector representation of user query as a search input for the hybrid search process.

The second data source 155 can retrieve second results corresponding with data searched during the second search process. For example, retrieving second results can include receiving a structured query or vector representation as a search input and identifying one or more nodes or relationships within the knowledge graph corresponding to the search input. Identifying one or more nodes can include analyzing connections, attributes, or relationships stored as edges between nodes in the knowledge graph. Analyzing can include evaluating one or more accuracy values. For example, the second results can have or be associated with an accuracy value. The accuracy value can include or refer to metrics associated with a relevance or confidence of the identified nodes or relationships in relation to the search input (e.g., structured query). For example, the second data source 155 can calculate accuracy values based on the strength or type of connections between nodes, semantic alignment of node attributes with the query, or contextual relevance of the identified relationships. Identifying or determining accuracy values can include using graph traversal techniques, weighting of edge types, or similarity measures between query attributes or node properties to determine whether the knowledge graph data corresponds with the user query.

The modeling system 160 can select results. For example, the modeling system 160 can include any combination of hardware or software for modeling and selecting between results to provide in response to the user query. The modeling system 160 can select one of first results and second results. For example, the modeling system 160 can select results of first search process of a hybrid search operation and results of a second search process of the hybrid search operation. The modeling system 160 can select results based on accuracy values. For example, the modeling system 160 can select one of the first results or the second results based on modeling the first accuracy value and the second accuracy value. Modeling the first accuracy value and the second accuracy value can include executing scoring or weighting algorithms, using predictive machine learning models, implementing heuristic-based ranking techniques, comparing results to thresholds, or analyzing statistical confidence metrics. The modeling system 160 can provide the select results to the client device 110 or chatbot interface 115 for output.

Internal data objects 165 can include or refer to organizational or verified data. For example, internal data objects 165 can include data stored in one or more repositories or data stores managed by or associated with the computing system 120. Internal data objects 165 can include verified or pre-validated content. Verified or pre-validated content can include or refer to data that is reviewed or analyzed to determine accuracy, relevance, or adherence to organizational standards. For example, internal data objects 165 can include knowledge base articles, regulatory compliance data, or organizational guidelines managed by or associated with computing system 120 or an entity associated with computing system 120. For example, internal data objects 165 can include web pages, organizational FAQs, internal process documentation, or proprietary datasets. Internal data objects 165 can include various data accessed by the hybrid search system 145, first data source 150, second data source 155, or other systems or sub-systems of FIG. 1 during various search operations or processes.

External data objects 170 can include or refer to data from public or third-party sources. For example, external data objects 170 can include data stored in public databases, third-party repositories, or web-based platforms that are not managed by or directly associated with the computing system 120. External data objects 170 can include unverified or dynamically sourced data. Unverified or dynamically sourced data can include or refer to information retrieved from external sources without prior review or validation for accuracy or relevance. For example, external data objects 170 can include publicly available knowledge bases, industry reports, regulatory documents, or data from third-party APIs. External data objects 170 can also include web-based resources, social media content, or publicly accessible datasets. External data objects 170 can include various data accessed by the hybrid search system 145, first data source 150, second data source 155, or other systems or sub-systems of FIG. 1 during various search operations or processes.

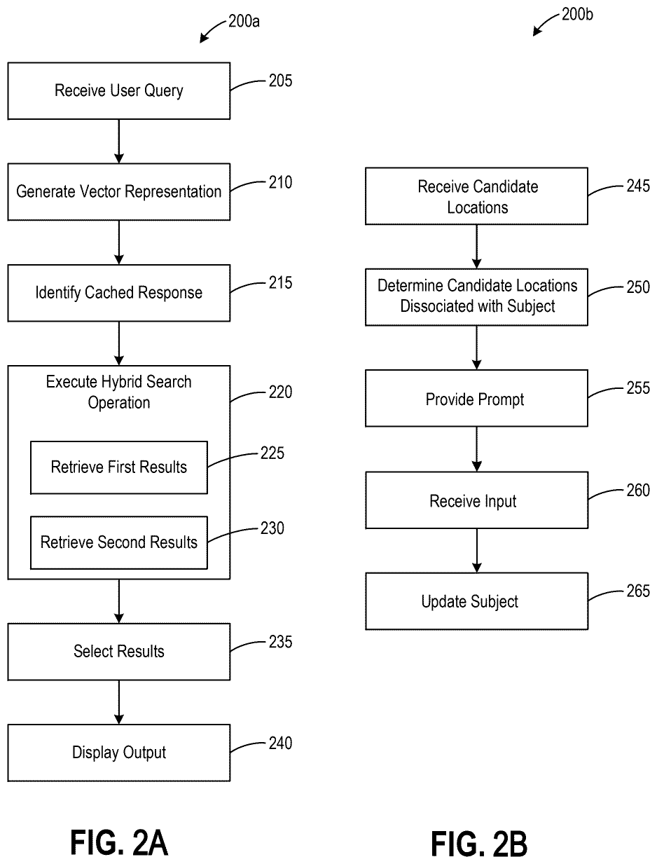

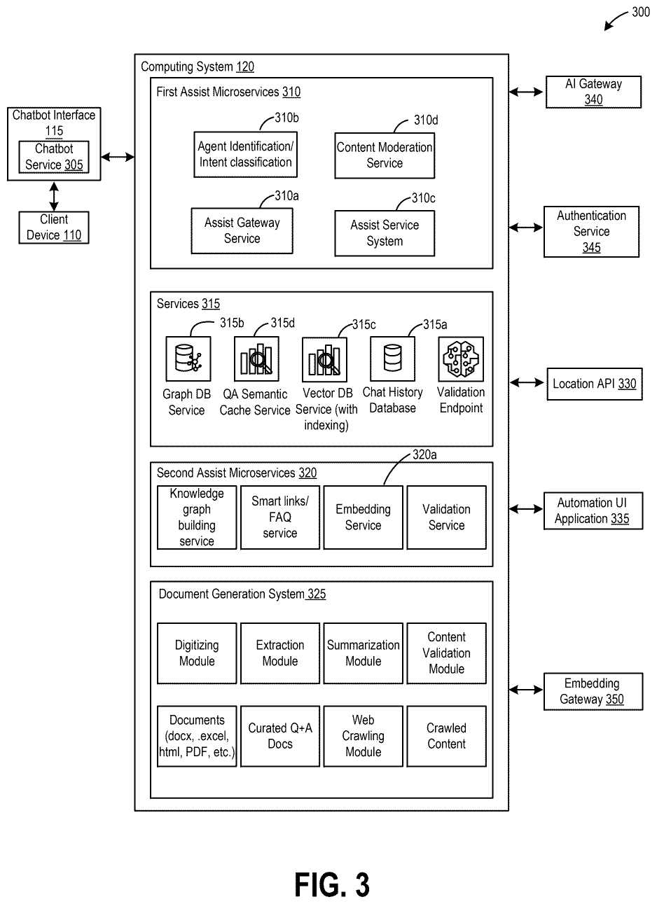

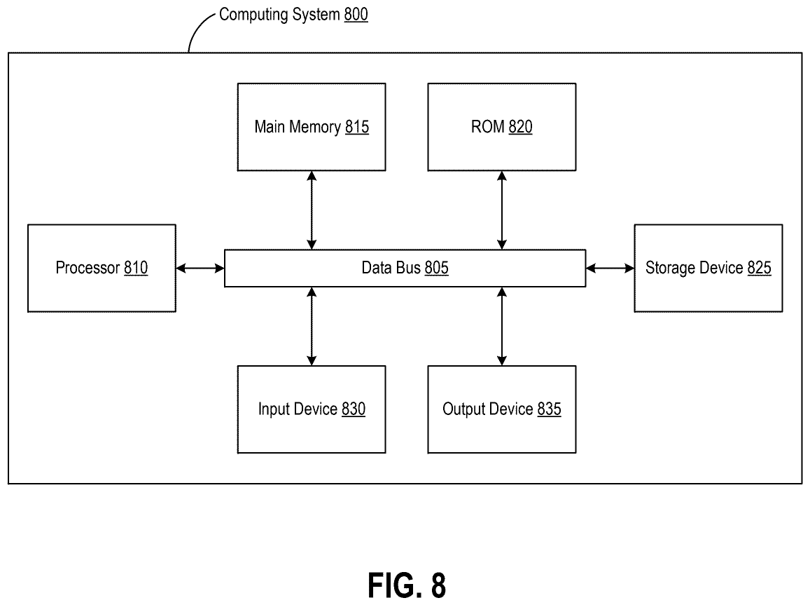

FIGS. 2A-2B show illustrative examples of computer-implemented methods 200a-200b for vector-based hybrid search for chatbots. Methods 200a-200b can be implemented using various systems, devices, or components discussed herein (e.g., one or more processors, system 100 or computing system 120 of FIG. 1, system 300 of FIG. 3, system 800 of FIG. 8, etc.). Methods 200a-200b can include one or more of acts 205-265. Referring now to FIG. 2A, the method 200a can include receiving a user query at act 205. Act 210 can include generating a vector representation. Act 215 can include identifying a cached response. Act 220 can include executing a hybrid search operation. Executing a hybrid search operation at act 220 can include retrieval of first results at act 225. Executing a hybrid search operation at act 220 can include retrieval of second results at act 230. Act 235 can include selecting results. Act 240 can include displaying an output.

Act 205 can include receiving a user query. For example, method 200a can include receiving, by one or more processors coupled with memory, via a chatbot, a user query. Receiving a user query can include analyzing textual input, voice commands, or other forms of query data provided to a chatbot. For example, receiving a user query can include the chatbot interface 115 processing an input via the client device 110 and transmitting data corresponding to the input to computing system 120. Receiving a user query can include mapping the input data to an active session associated with chatbot interface 115 or forwarding the query data to embedding system 125 for generating a vector representation. Receiving a user query can include determining if a query is adversarial or non-adversarial based on a subject of the query. For example, the computing system 120 can transmit data corresponding with the user query to a content moderation service to determine if the user query relates to acceptable or unacceptable subject matter (e.g., political topics).

Act 210 can include generating a vector representation. For example, method 200a can include generating, by the one or more processors, using an artificial intelligence model, a vector representation based on a combination of the user query, one or more historical queries, and one or more responses corresponding to the one or more historical queries at act 210. Generating a vector representation can include executing one or more embedding algorithms or techniques to generate a modeled query. For example, generating a vector representation can include the embedding system 125 or AI model 130 analyzing linguistic, semantic, and contextual elements of the user query and a corresponding chat history (e.g., historical queries and corresponding responses). Generating a vector representation can include the embedding system 125 or AI model 130 summarizing the user query and the chat history and mapping elements or features of the user query and the chat history to a multidimensional vector space.

For example, at act 210, the AI model 130 can receive a user query, such as “What is the minimum wage in Portland?” The AI model 130 can determine that the query is non-adversarial and summarize the user query and a chat history (e.g., a historical query or response, such as “What are labor laws in Oregon?”). The AI model 130 can execute one or more embedding algorithms to map tokens, phrases, and relationships included in the user query or chat history into a multidimensional vector space. The vector space can include dimensions representing specific attributes such as geographic location (e.g., state, city, or region), legal domain (e.g., wage regulations, employment statutes), and temporal context (e.g., current laws, historical precedents).

Act 215 can include identifying a cached response. For example, the method 200a can include identifying, by the one or more processors, a cached response corresponding to the user query in a semantic cache. Identifying a cached response can include execution of a semantic search operation using the vector representation. For example, the cache search system 135 can provide the vector representation corresponding with the user query to the semantic cache 140 to retrieve a cached response.

Upon, responsive to, or subsequent to receiving the vector representation, the semantic cache 140 can execute a semantic search operation. For example, if the vector representation corresponds to a query like “What is the minimum wage in Seattle?”, the semantic cache 140 can compare the received vector representation to stored vector representations of cached queries. The semantic cache 140 can identify a stored vector representation corresponding to a cached query, such “What is the minimum wage in Washington state?” For this query, the semantic cache 140 can calculate a similarity score or accuracy value between the received vector representation and stored vector representations. Here, the semantic cache can determine a high similarity score due to alignment across dimensions, including geographic attributes (e.g., Seattle, Washington), regulatory topics (e.g., labor laws), or temporal context (e.g., 2024). Based on the similarity score, the semantic cache 140 can retrieve a cached response corresponding to the cached query (e.g., “The current minimum wage in Washington is $15.74 per hour”) and provide the cached response.

In some implementations, at act 220, the method 200a can include determining to execute the hybrid search operation based on determining that the cached response fails to satisfy at least one threshold. For example, if the vector representation corresponds to a query such as “What is the average cost of living in Seattle?”, the semantic cache 140 can compare the received vector representation to stored vector representations and identify cached queries such as “What are the living costs in Portland?” or “What is the average cost of living in San Francisco?” While these cached queries can correspond to the user query based on shared contexts or features (e.g., relevance to cost of living or urban areas), the semantic cache 140 can calculate similarity scores or accuracy values to determine if the cached query can be provided as a response to the user query based on dimensions such as geographic attributes (e.g., city, state), contextual relevance (e.g., cost of living), and temporal context (e.g., 2024). In this example, the semantic cache 140 can determine that the similarity scores or accuracy values indicate some correspondence but fall below a threshold. In response, the semantic cache 140 can provide the cached query (e.g., as the closest match) or provide an indication that none of the identified cached queries can be provided in response to the user query. In an example, the cache threshold used in connection with the cached response can be adjusted (e.g., lowered or relaxed, or increased, etc.) based on the subject or context of the query. In an example, in response to determining the cached queries stored in the semantic cache 140 do not match the user query modeled by the embedding system 125 or AI model 130, the computing system 120 can execute a hybrid search operation.

Act 220 can include executing a hybrid search operation. For example, the method 200a can include executing, by the one or more processors, based on the cached response, a hybrid search operation associated with the user query. Executing a hybrid search operation can include searching or querying various data sources (e.g., first data source 150, second data source 155, internal data objects 165, external data objects 170, etc.) to retrieve results. For example, executing a hybrid search can include retrieval of first results at act 225 and retrieval of second results at act 230 based on a search input. Act 220 can include providing search inputs (e.g., vector representation, structured query, etc.) to one or more data sources to execute various search processes. In an example, retrieving results from a hybrid search (e.g., first search process, second search process, etc.) can include executing various informational retrieval or ranking algorithms to select documents or results from a data source based on relevance or context, including a maximal marginal relevance (MMR) algorithms or best matching 25 (BM25) ranking functions.

Act 225 can include executing a first search process. For example, the method 200a can include retrieving, by the one or more processors, first results having a first accuracy value by execution of a first search process of the hybrid search operation on a first data source using the vector representation. The first search process can include generating, by the one or more processors, an index including a plurality of vector representations of content or data objects based on scanning a plurality of documents. For example, the first data source 150 can index data objects stored in repositories managed by the computing system 120 and provide one or more data objects as outputs or results. The first search process can include determining, by the one or more processors, one or more scores representing similarities between the plurality of vector representations of the data objects and the vector representation corresponding with the modeled user query. For example, the hybrid search system 145 or first data source 150 can apply cosine similarity, semantic matching, or other scoring algorithms to determine accuracy values (e.g., similarity scores, relevance criteria, or other metrics) associated with the user query and stored data objects.

The first search process can include providing, by the one or more processors, the first results. Providing the first search results can include providing data of the plurality of documents in response to determining at least one score of the one or more scores satisfies at least one threshold corresponding to the first accuracy value. For example, the hybrid search system 145 can use embedding-based search techniques to analyze the received vector representation by comparing the vector representation to indexed or stored data objects of the first data source 150. The hybrid search system 145 can determine an accuracy value, similarity score, or other metric by calculating or modeling similarity and/or distance between the vector representation and the stored or indexed objects. Further, hybrid search system 145 can compare the accuracy value, similarity score, or other metric to a predefined threshold to determine that the score, value, or metric satisfies a predefined threshold or value (e.g., a value exceeding 0.8 for cosine similarity, a distance below 0.3 for Euclidean distance) That is, a threshold can include a value or metric corresponding with an accuracy value or indicating that similar linguistic, semantic, or contextual elements exist between the vector representation of the user query and one or more of the data objects.

Upon, responsive to, or subsequent to determining a threshold is satisfied, the first data source 150 can rank the identified data objects in order of relevance and return the ranked data object to the computing system 120 for further processing. For example, the first data source 150 can provide a list of the top N documents corresponding to the vector representation of the user query. The first results can include or be associated with an accuracy value. The accuracy value can refer to one or more similarity metrics or relevance scores between the first results and the user query.

Act 230 can include executing a second search process. For example, the method 200a can include retrieving, by the one or more processors, second results having a second accuracy value by execution of a second search process of the hybrid search operation on a second data source using data corresponding to the vector representation. The data corresponding to the vector representation can include a structured query corresponding to a schema of a knowledge graph. Retrieving second results can include searching the knowledge graph using the structured query as input. To determine the structured query, the method 200a can include mapping, by the one or more processors, one or more portions of the vector representation to at least one node type, node attribute, or edge type corresponding to the plurality of nodes and edges based on the schema. Mapping can include the hybrid search system 145 analyzing the schema to map portions of the vector representation to node types, attributes, or edge types defined in the knowledge graph. The method 200a can further include generating, by the one or more processors, the structured query including the at least one node type, node attribute, or edge type. For example, the hybrid search system 145 can generate a cipher query that includes one or more database or graph parameter or operations (e.g., MATCH patterns to locate nodes and edges, WHERE clauses to apply constraints based on node or edge attributes, and RETURN statements to retrieve nodes, relationships, or subgraphs that align with the structured query).

The second search process can include searching the knowledge graph. For example, the knowledge graph can include a plurality of nodes and edges connecting the plurality of nodes, and the hybrid search system 145 can execute the second search process by traversing the knowledge graph and identifying nodes or relationships (e.g., edges) associated with the vector representation. For example, the hybrid search system 145 can execute graph traversal operations, including breadth-first or depth-first searches, to locate relevant nodes and edges within the second data source 155. Retrieving nodes and relationships from the knowledge graph can further include evaluating attributes, edge weights, or connectivity metrics to determine relevance of knowledge graph data to the user query. For example, the second data source 155 can compute a second accuracy value corresponding with a relevance or similarity between the knowledge graph data and the user query or structured query.

Act 235 can include selecting results. For example, the method 200a can include selecting, by the one or more processors, one of the first results or the second results based on modeling the first accuracy value and the second accuracy value. Modeling the first accuracy value and the second accuracy value can include determining which of the first results and the second results match or align with the user query. For example, determining whether the results match or align with the user query can include comparing the first accuracy value and the second accuracy value using a weighted scoring system or ranking algorithm. The weighted scoring system can assign numeric weights to various parameters of the results, such as semantic similarity scores, contextual alignment scores, or confidence scores corresponding with results of each data source.

The method 200a can include generating aggregating results. For example, the method 200a can include aggregating, by the one or more processors, the first results and the second results to generate aggregated results. Aggregating the first and second results can include summarizing or combining data objects, attributes, or relationships from both sets of results into a unified dataset for ranking. For example, the AI model 130 or modeling system 160 can summarize the first and second results using artificial intelligence techniques. The method 200a can include ranking, by the one or more processors, the aggregated results based on at least one of the first accuracy value, the second accuracy value, or a third accuracy value generated by the artificial intelligence model. For example, ranking can include the AI model 130 or modeling system 160 determining whether the first accuracy value of the first results, the second accuracy value of the second results, or a third accuracy value satisfy a threshold. The method 200a can include selecting, by the one or more processors, using the artificial intelligence model, a subset of the aggregated results satisfying at least one threshold. For example, the subset can include data objects or relationships ranked highest by the artificial intelligence model based on contextual relevance, semantic alignment, or preferences derived from the user query and historical interactions. Further, the subset can include a group or portion of the ranked objects corresponding with accuracy values satisfying one or more predefined metrics to verify accuracy. The method 200a can further include displaying, using the chatbot, the output including the subset in response to the user query.

Act 240 can include displaying an output. For example, the method 200a can include displaying, by the one or more processors, responsive to the user query, an output corresponding to the selected one of the first results or the second results. For example, the computing system 120 (e.g., via the AI model 130 or modeling system 160) can provide data (e.g., results, modeled or generated response, etc.) to the client device 110 for display. For example, the client device 110 can display an output corresponding to the selected one of the first results or the second results as a prompt or response to the user query via the chatbot interface 115. For example, the chatbot interface 115 can present the selected result or response as text, links, or other interface elements via an interface of chatbot interface 115 executing on client device 110.

The method 200a can include issuing, by the one or more processors, one or more automated requests to a plurality of internal sources including verified content. For example, issuing automated requests can include querying internal repositories (e.g., internal data objects 165) to retrieve data from regulatory compliance documents, organizational guidelines, or knowledge base articles. The method 200a can include generating, by the one or more processors, a second plurality of vector representations corresponding to verified data extracted from the verified content. For example, generating the second plurality of vector representations can include processing extracted entities (e.g., text, metadata, or structured information) from the verified documents or data objects to create embeddings representing semantic relationships, contextual meaning, or attributes of the entities included in the verified data. The method 200a can include storing, by the one or more processors, the second plurality of vector representations in an index accessible to the first data source. For example, storing the vector representations can include adding embeddings derived from the verified compliance data or organizational guidelines into an index accessible to the first data source 150 to facilitate similarity-based search operations.

The method 200a can include identifying, by the one or more processors, using the artificial intelligence model, a subject of the user query corresponding to at least one location. A subject can refer to an overall context or meaning associated with a user query. For example, identifying a subject can include analyzing linguistic, semantic, or contextual elements of the user query. For example, the AI model 130 can identify that the query corresponds with a city name or geographic region, a payroll question (e.g., “What is the minimum wage in Portland?”), and so on. The method 200a can include determining, by the one or more processors, using the artificial intelligence model, the at least one location corresponds to multiple locations or is incomplete. For example, the AI model 130 can determine ambiguities in the user query corresponding with a location term mapping to multiple possible locations or lacking sufficient detail for identification (e.g., a street name without a city). The method 200a can include disambiguating, by the one or more processors, the at least one location by execution of one or more computer-executable instructions. For example, disambiguating can include transmitting a query to an external location database or service (e.g., application programming interface or API) to retrieve additional contextual or geospatial data for resolving ambiguities in the location. For example, based on the mapped dimensions of geographic location from the user query and chat history, the AI model 130 can determine that a context or subject of the user query pertains to Portland, Oregon, rather than Portland, Maine, and the AI model 130 can generate a vector representation based on the determined context or subject.

The method 200a can include categorizing, by the one or more processors, the user query in a query category based on a predefined taxonomy of query types. A predefined taxonomy may include or refer to classifications such as minimum-wage queries, location-based queries, entity-specific queries, informational queries, and so on. For example, categorizing can include analyzing linguistic, semantic, or structural features of the user query and mapping the query to a corresponding category by applying predefined classification rules, calculating similarity scores in a multidimensional vector space, or evaluating contextual attributes against the taxonomy criteria. The method 200a can include selecting, by the one or more processors, search parameters for the hybrid search operation based on the query category. Selecting search parameters can further include adjusting relevance thresholds, weighting vector dimensions, or applying context-aware filters to align the hybrid search operation with the identified query category. For example, selectin can include pre-filtering one or more query results (e.g., cached Q&A pairs) to reduce latency during searches. The search parameters can be provided along with a search input in various search operations.

The method 200a can include determining, by the one or more processors, the first accuracy value and the second accuracy value based on a subject of the user query. Determining can include adjusting the first or second accuracy value to provide more or less accurate search results. For example, determining the first accuracy value and the second accuracy value can include assigning higher thresholds for accuracy when the subject of the query pertains to topics such as compliance regulations or legal requirements, compared to lower thresholds for general informational topics. The method 200a can include adjusting, by the one or more processors, the first accuracy value or the second accuracy value in response to receiving a new query. Adjusting the first or second accuracy value can cause the first data source 150 or the second data source 155 to provide more accurate or less accurate results via search operations. Determining or adjusting the first accuracy value or the second accuracy value can include determining or adjusting one or more thresholds corresponding with the first and second accuracy values.

The method 200a can include determining, by the one or more processors, that the first results failing the first accuracy value and the second results failing the second accuracy value. For example, determining the failure can include analyzing the relevance, confidence, or contextual alignment of the first and second results and identifying that neither of the results satisfy one or more predefined thresholds. In some examples, a predefined threshold can correspond to results of benchmarking or testing performed for a topic. For example, benchmarking or testing can include performing simulations or controlled tests where test queries are executed against known datasets and returned results are evaluated based on various similarity-based or context-based metrics (e.g., a proportion of correctly identified results relative to retrieved results (precision), proportion of correctly identified results relative to relevant results in the dataset (recall), a combination of precision and recall scores (e.g., F1 score), semantic similarity, etc.). Simulating test queries can include performing cache queries to retrieve results, comparing the results to a threshold, varying the threshold incrementally, analyzing how changes in the threshold affect the accuracy of result identification for one or more topics (e.g., by comparing the results to an established ground truth dataset). In some examples, testing can include incorporating or providing prompts or user feedback loops for evaluators or operators to review or validate outputted results against a threshold.

The method 200a can include initiating, by the one or more processors, a third search of one or more third data sources, the one or more third data sources corresponding to a plurality of external links which direct to a plurality of external content. A third search may include or refer to a bridge search operation. For example, executing a third search can include executing a bridge search. For example, initiating the third search can include querying internal or external data repositories (e.g., internal data objects 165, external data objects 170, etc.), various APIs, or content aggregation services to retrieve supplemental information or results. The plurality of external links can include references to publicly available web pages, documents hosted on third-party platforms, or URLs associated with structured or unstructured data sources that align with the context of the user query and provide access to linked data (e.g., web pages, documents, etc.) in response to selection or interaction.

The method 200a can include retrieving, by the one or more processors, one or more links of the plurality of external links relevant to the user query based on a content relevance score associated with the plurality of external content. For example, the relevance score can include a numerical or weighted metric derived from factors such as semantic similarity between the user query and the external content, keyword matches, metadata tags, or link context within the external data source. The method 200a can include providing, by the one or more processors, a prompt including the one or more links via the chatbot in response to the user query. Providing can include generating a prompt via the chatbot interface 115 that includes external links formatted for user selection. For example, the prompt can include a listing of links and textual descriptions, numerical relevance scores, or contextual summaries associated with the external links as a response to the user query.

Referring now to FIG. 2B, the method 200b can include receiving one or more candidate locations. For example, at act 245, the method 200b can include receiving, by the one or more processors, responsive to the disambiguation, a plurality of candidate locations corresponding to the at least one location. For example, the plurality of candidate locations can include location identifiers or metadata retrieved from an external data source. At act 250, the method 200b can include determining, by the one or more processors, using the artificial intelligence model, the plurality of candidate locations are dissociated with the subject. For example, determining can include the AI model 130 executing various techniques to evaluate semantic or contextual similarities between the candidate locations and the subject of the user query using vector analysis or relevance scoring. At act 255, the method 200b can include providing, by the one or more processors, via the chatbot, a prompt including one or more location queries corresponding to the at least one location, the multiple locations, or the plurality of candidate locations. For example, the chatbot interface 115 can provide a prompt with multiple location options for selection or provide additional information via the chatbot (e.g., “Are you referring to Portland, Maine or Portland, Oregon?”). For example, in response to receiving a user query with ambiguous location information, the client device 110 can prompt the user for additional input to clarify the query by causing the chatbot interface 115 to display a follow-up question with a corresponding user input field. In some aspects, the client device 110 can update the arrangement of elements of the chatbot interface 115 to display one or more options (e.g., a dropdown menu listing states) corresponding to possible or candidate locations in response to determining a user query is ambiguous or incomplete.

At act 260, the method 200b can include receiving, by one or more processors, via the chatbot, an input responsive to the prompt. For example, the chatbot interface 115 can transmit data to a chatbot service to determine or identify a selection of one or more location options or input text clarifying the location term. At act 265, the method 200b can include updating, by the one or more processors, the subject of the user query based on the input. For example, updating can include modifying the subject vector or query parameters to incorporate the clarified location details for subsequent search operations. For example, updating can include refining the user query by incorporating the clarified location information into the vector representation to facilitate more accurate downstream search operations.

FIG. 3 is an illustrative example of a system 300 for vector-based hybrid search for chatbots, in accordance with some implementations. The system 300 can include client device 110, which can interface with or execute chatbot interface 115 to receive queries or provide responses. Chatbot interface 115 can include and/or communicate with a chatbot service 305. The chatbot service 305 can include or refer to a conversational computing platform which processes natural language inputs, executes contextual modeling techniques, and generates responsive outputs based on a combination of pre-trained models and application-specific data. The chatbot interface 115 can provide data corresponding to a chatbot conversation to computing system 120 via a network (e.g., network 105). Each of the systems, sub-systems, or modules herein can refer to or include one or more processors coupled with memory (e.g., as shown on FIG. 8). Each of the services or micro services herein can refer to or include executable components or instructions associated with performing functions or processes using one or more processors coupled with memory.

The system 300 can include computing system 120. For example, computing system 120 can include or refer to an assist service orchestration architecture including various systems, services, microservices, or modules. The computing system 120 can include first assist microservices 310, which can include an assist gateway service 310a, an agent identification or intent classification service 310b, an assist service system 310c, a content moderation service 310d, or additional services or microservices (e.g., agent identification/intent classification service, etc.). Each of the microservices 310 can interface or communicate with additional services or modules or external sources (e.g., APIs, virtual networks, etc.) as further described herein (e.g., with regard to FIGS. 4A-4D, FIG. 2, FIG. 5, FIG. 6, FIG. 7, etc.) to perform various processes for assist service orchestration using a vector-based hybrid search. For example, the computing system 120 can receive the corresponding data and execute various processes or techniques to analyze the query and provide an accurate response using the assist microservices 310.

The computing system 120 can include services 315. The services 315 can include a history database service 315a, a graph database service 315b, a vector database service 315c, a semantic cache service 315d, or additional services or micro-services (e.g., a semantic caching service, a validation endpoint, etc.). Each of the services 315 can interface or communicate with additional services or modules or external sources as further described herein with regard to FIGS. 4A-4D, FIG. 2, FIG. 5, FIG. 6, FIG. 7. For example, the computing system 120 can execute various search processes or operations (e.g., hybrid search, first search process, second search process, semantic cache search, bridge search, etc.) to retrieve results using the services 315.

The computing system 120 can include second assist microservices 320. The assist microservices 320 can include a knowledge graph building service, a smart links/FAQ service, an embedding service 320a, and a validation service. Each of the assist microservices 320 can interface or communicate with additional services or modules or external sources as further described herein with regard to FIGS. 4A-4D, FIG. 2, FIG. 5, FIG. 6, FIG. 7. For example, computing system 120 can interface with AI gateway 340 using the embedding service 320a of assist services 320 to generate a vector representation. For example, computing system 120 can interface with graph database service 315b, vector database service 315c, and semantic cache service 315d of services 315 to perform vector-based searches or execute search queries.

The computing system 120 can include document generation system 325. The document generation system 325 can include any combination of hardware and software to analyze or store data for search operations or processes. For example, the document generation system 325 can include a digitizing module, an extraction module, a summarization module, a web crawling module, a content validation module, or additional modules (e.g., curation module, etc.). Each of the sub-systems or modules of document generation system 325 can interface or communicate with various modules or services or external sources as further described herein with regard to FIGS. 4A-4D, FIG. 2, FIG. 5, FIG. 6, FIG. 7. For example, the document generation system 325 can receive or identify documents (e.g., in formats including .docx, .PDF, .excel, etc.), digitize the documents, extract data from the documents, crawl data sources to identify crawled content, summarize the documents or content, generate curated Q&A docs based on the summarized documents or contents, and so on.

The computing system 120, first assist services 310, services 315, second assist services 320, and document generation system 325 can communicate or interface with a location API 330, an automation user interface (UI) application 335, an AI gateway 340, an authentication service 345, and an embedding gateway 350. The location API 330 can identify or resolve geographical locations associated with queries or documents. The automation UI application 335 can include a user interface and one or more testing modules to automatic tasks or simulate user interactions (e.g., workflows or input-output sequences) to test various services or modules. The AI gateway 340 can interface with various cloud-based AI models to analyze or model a user query. For example, the AI gateway 340 can generate a summary based on query data or select or rank retrieved results. The authentication service 345 can manage authentication, authorization, or access control by verifying user credentials, providing tokens, or verifying permissions for accessing specific services or data. For example, the authentication service 345 can include an identity and access management (IAM) gateway. In some embodiments, the authentication service 345 can refer to an authentication service or microservice corresponding with an entity associated with computing system 120. In some embodiments, the authentication service 345 can include a third-party interface or gateway external to computing system 120. The embedding gateway 350 can generate, retrieve, or manage vector-based embeddings for processing, searching, or ranking results. For example, the AI gateway embedding gateway 350 can facilitate semantic similarity scoring, content ranking, or clustering operations by converting textual or other input data into numerical or vector representations for vector-based searches.

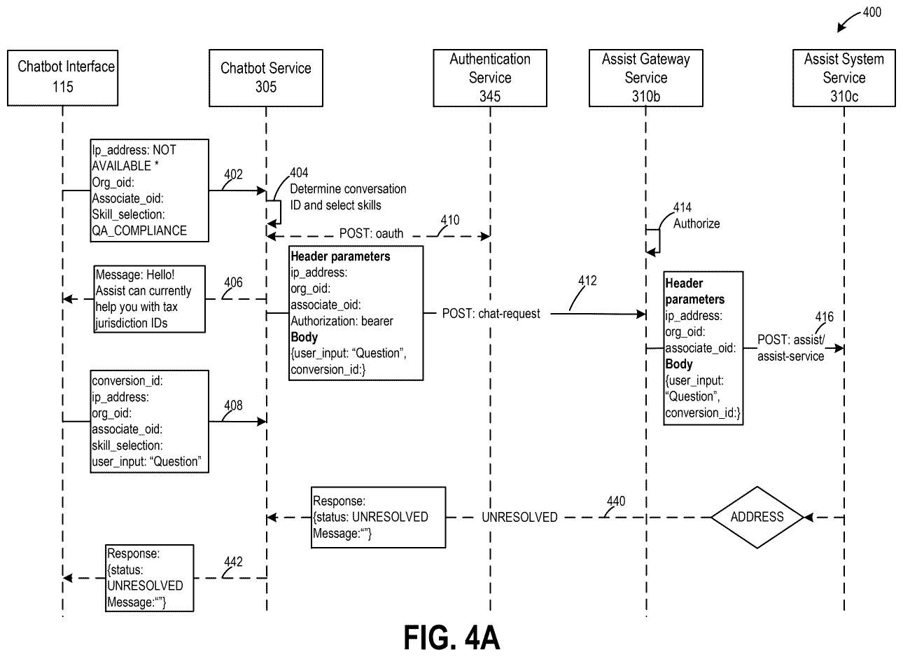

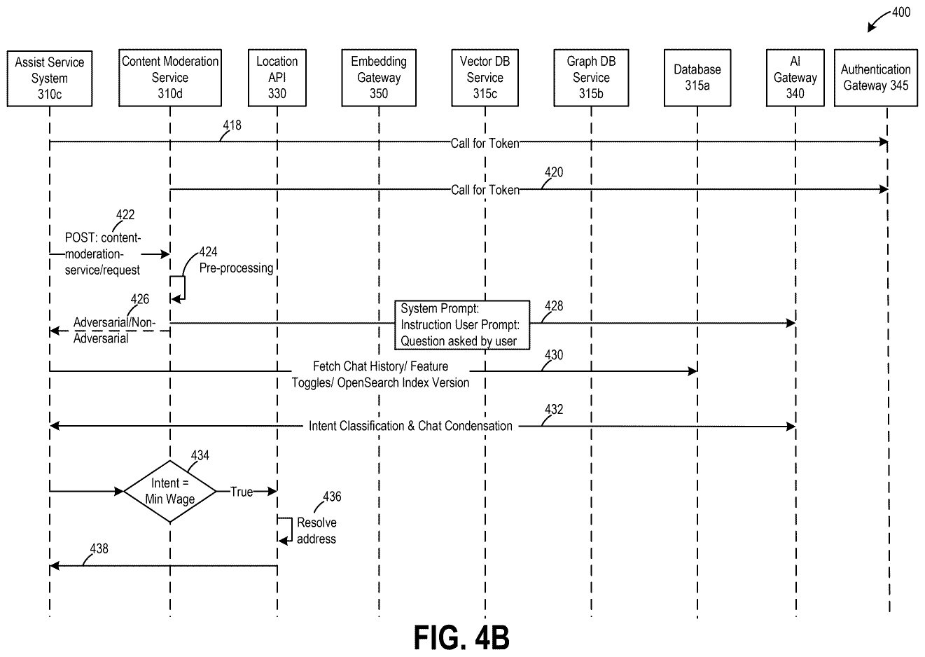

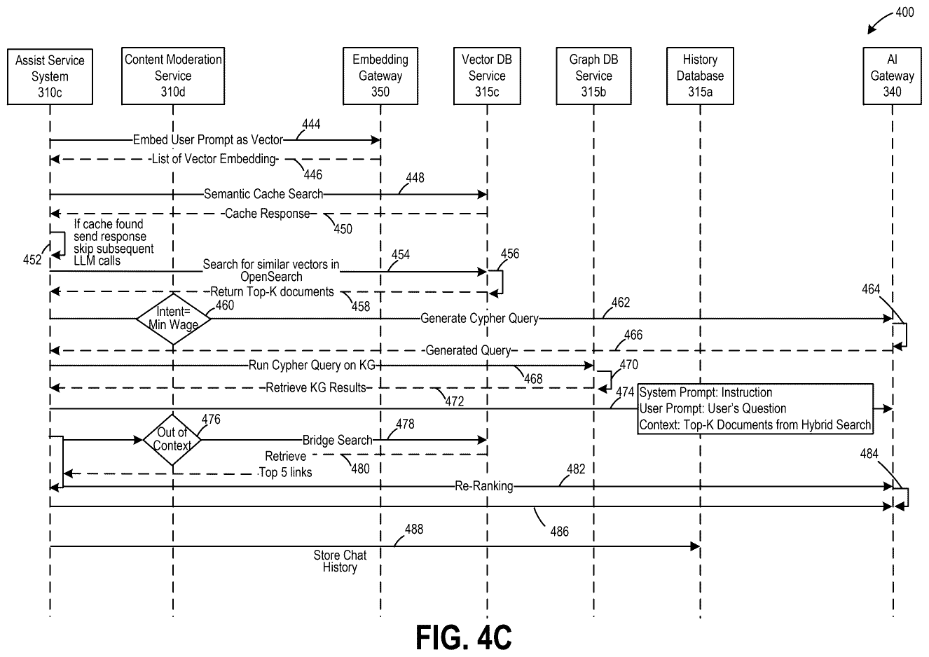

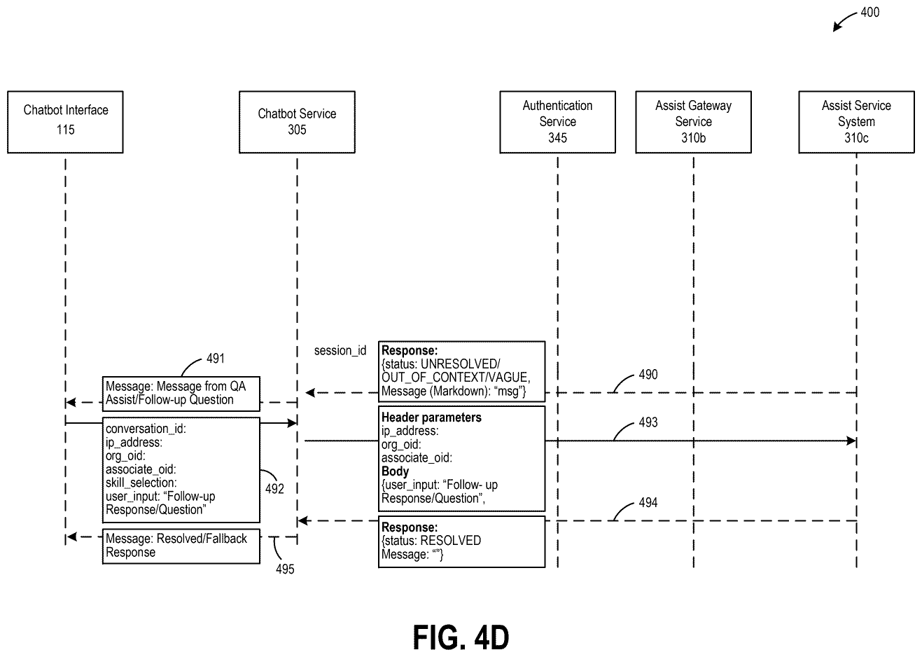

FIGS. 4A-4D depict an illustrative example of a computer-implemented method 400 for vector-based hybrid search for chatbots, in accordance with some implementations. Referring to FIG. 4A, at act 402, the chatbot interface 115 can transmit a request to the chatbot service 305. For example, the chatbot interface 115 can establish a chatbot session via the request transmitted to the chatbot service 305. At act 404, the chatbot service 305 can determine a conversation ID (e.g., session ID) and select skills. For example, the chatbot service 305 can analyze session metadata and input characteristics to assign one or more operational modules (e.g., intent classification, data retrieval, or response generation) for processing the session. At act 406, the chatbot service 305 can transmit a prompt for display via chatbot interface 115. The prompt can include an introduction or message (e.g., “Hello”).

At act 408, the chatbot interface 115 can receive and transmit a user query. For example, the chatbot interface 115 can transmit a request or message, including a user input (e.g., a user question) and various request data (e.g., headers, session identifiers, etc.) to the chatbot service 305. At act 410, the chatbot service 305 can transmit an authentication request to the authentication service 345. For example, the chatbot service 305 can include request data such as session identifiers or access tokens in the authentication request and receive a response including authentication confirmation or access attributes for the session. At act 412, the chatbot service 305 can transmit a gateway request. For example, the chatbot service 305 can send a request or message (e.g., POST request) to gateway assist service 310b to access assist service system 310c. The request can include header data (e.g., IP address, organization identifier, etc.) and body data (e.g., user input, a metadata tag such as “Question,” a conversation identifier or session ID, etc.).

At act 414, the assist gateway service 310b can authorize access. For example, upon, responsive to, or subsequent to receiving a gateway request at act 412, the assist gateway service 310b can authorize access to the assist service system 310c. Authorizing can include evaluating the request data (e.g., metadata tags, session identifiers, or organization codes) against stored access policies or rules to determine whether access to assist service system 310c is permitted or validated. At act 416, the assist gateway service 310b can transmit a request to the assist service system 310c. For example, the request can include a POST request with various header parameters (e.g., IP address, organization ID, etc.) and a body containing the user query. The method 400 can further include acts 440-442, which are described further herein with regard to FIGS. 4B-4C.

Referring now to FIG. 4B, at act 418, the assist service system 310c can transmit a call for a token. For example, the assist service system 310c can transmit a request to the authentication service 345 at predefined intervals (e.g., every thirty minutes) to receive tokens. Tokens can include or refer to session-based authentication credentials or access keys that validate ongoing communications between the assist service system 310c and other connected services. At act 420, the content moderation service 310d can transmit a call for a token to authentication service 345. For example, the call can authenticate the moderation request or validate session continuity. At act 422, the assist service system 310c can transmit a request to perform content moderation on the user query. For example, upon, subsequent to, or in response to receiving a token from the authentication service 345, the assist service system 310c can transmit the user query to content moderation service 310d to determine if a subject of the query is non-adversarial.

At act 424, the content moderation service 310d can pre-process the user query. Pre-processing can include parsing the query to extract relevant entities, normalizing text for consistent analysis (e.g., converting to lowercase, removing special characters), and analyzing linguistic features such as sentiment or intent to prepare the user query for further evaluation or processing. At act 426, the content moderation service 310d can transmit a request or message to the assist service system 310c indicating if the subject of the query is adversarial or non-adversarial. For example, the message can include a flag or a tag indicating the classification of adversarial or non-adversarial. At act 428, the content moderation service 310d can transmit a prompt to the AI gateway 340. For example, the prompt may include a system-level instruction (e.g., “Retrieve context for sentiment analysis”) and a user-level input (e.g., the question or query). At act 430, the assist service system 310c can retrieve or fetch a chat history. For example, upon, responsive to, or subsequent to determining a response can be provided to the user query (e.g., non-adversarial), the assist service system 310c can transmit a request to chat history database service 315a to retrieve results. In response, the history database service 315a can provide one or more past queries and corresponding responses to the assist service system 310c for modeling the user query.

At act 432, the assist service system 310c determine a subject or intent of the user query. For example, the assist service system 310c can transmit a request including the retrieved chat history and user query to the AI gateway 340 to classify or condense the transmitted data. The AI gateway 340 can model the user query and chat history to generate a single or standalone query (e.g., using a classifier). At act 434, the assist service system 310c can determine the user query is ambiguous and transmit data to an endpoint to resolve the ambiguity. For example, the assist service system 310c can determine an intent of the query (e.g., minimum wage) and that the modeled query includes a location ambiguity, and can transmit the modeled query or other data to the location API 330 to resolve the query at act 436. In some examples, the user query can include or correspond with multiple topics or intents. Resolving the user query can include processing the modeled query to identify and integrate additional contextual data addressing ambiguities in the query. For example, the location API 330 can analyze structured data elements from the modeled query and apply geospatial algorithms or referential mappings to determine precise or inferred location attributes, such as coordinates, jurisdictional boundaries, or named entities, based on query metadata and available datasets. At act 438, the location API 330 can transmit a resolved query. For example, responsive to disambiguating a location of the user query, the location API 330 can transmit the disambiguated location to the assist service system 310c. Referring to FIG. 4A, in response to determining the address or location of the query is unresolved, the assist service system 310c can transmit a status indication or notification (e.g., “unresolved” message) to the chatbot service 305 at act 440. At act 442, the chatbot interface 115 can display or present the notification or message via an interface.

Referring now to FIG. 4C, at act 444, the assist service system 310c can transmit a request to generate a vector embedding. For example, the assist service system 310c can send the modeled query to embedding gateway 350 to embed the modeled query as a list of vector representations. At act 446, the assist service system 310c can transmit the list of vector representations to the assist service system 310. The list of vector representations can include numerical representations of the modeled query derived from embedding techniques, such as multi-dimensional arrays corresponding to semantic attributes (e.g., context, keywords, intent). At act 448, the assist service system 310c can execute a semantic cache search. For example, the assist service system 310c can transmit a request or call to the vector database service 315c to execute a cache search operation on a semantic cache. The semantic search operation can identify a cached response, which can match or fail to match with the user query. At act 450, the assist service system 310c can provide the cached response to the assist service system 310c.

At act 452, if a cached response is found, the assist service system 310c can transmit the cached response to the chatbot interface 115 as a response to the query and the method 400 can end. If a cached response is not found, the method 400 can continue with act 454. At act 454, the assist service system 310c can execute a first search process of a hybrid search operation. For example, the assist service system 310c can transmit a call or request to the vector database service 315c to search for vectors within a data source (e.g., first data source 150) similar to the vector representation of the modeled user query. At act 456, the vector database service 315c can execute a search. For example, the vector database service 315c can search the first data source 150 using a keyword-based or indexed search operation using elements of the user query or related metadata. Additionally, the search can use ranking algorithms, filtering, or contextual matching techniques to prioritize results based on relevance to the query. At act 458, the vector database service 315c can provide search results. For example, the vector database service 315c can transmit a list of the top ranked documents identified during the first search process.

At act 460, the content moderation service 310d can determine an intent of the user query. For example, the content moderation service 310d can analyze linguistic patterns, contextual metadata, or semantic embeddings to identify a probable subject or purpose of the user query, such as retrieving data, seeking clarification, or requesting an operation. At act 462, the content moderation service 310d can transmit data corresponding with the query to the AI gateway 340 to generate a cipher query. For example, the content moderation service 310d can transmit data associated with a user query (e.g., chat history, modeled query, metadata, timestamps, or other query data) or data associated with a graph database (e.g., database type, query schemas, formatting parameters, etc.) to the AI gateway 340. At act 464, the AI gateway 340 can generate a cipher query. For example, a cipher query can refer to a structured query modeled based on a database schema and used in database queries to retrieve data from a corresponding graph database (e.g., knowledge graph). For example, generating the cipher query can involve mapping the user query and associated metadata to nodes, relationships, and properties defined by the schema of the target knowledge graph (KG). The AI gateway 340 can execute or interface with one or more AI models to analyze the query intent and context to identify relevant nodes (e.g., entities such as locations or products) and edges (e.g., relationships such as “located in” or “belongs to”) within the KG. Additionally, the AI gateway 340 can construct the cipher query by iterating through the graph schema, selecting appropriate traversal paths, or applying constraints (e.g., WHERE clauses) based on user-specific parameters or metadata (e.g., time ranges, categories).

At act 466, the AI gateway 340 can transmit the structured query to the assist service system 310c. At act 468, the assist service system 310c can receive the structured query and transmit the structured query to the graph database service 315b for a database search. At act 470, the graph database service 315b can execute a second search process. For example, the graph database service 315b can traverse the second data source 155 (e.g., knowledge graph) by interpreting the structured query to identify relevant nodes, edges, and properties of the graph based on the query schema. The traversal can include applying graph-specific algorithms, such as shortest-path calculations, neighborhood exploration, or subgraph matching, to retrieve entities and relationships that align with query parameters. Additionally, the search process can include various features or optimizations, such as indexing specific node types or precomputing frequently queried relationships, to improve efficiency and scalability across large datasets or graphs.

At act 472, the graph database service 315b can provide search results. For example, the graph database service 315b can transmit the results retrieved from the graph database search at act 470 to the assist service system 310c. At act 474, the assist service system 310c can transmit a prompt to the AI gateway 340. For example, the prompt can include fields for a system prompt (e.g., instruction), a user prompt (e.g., a user's question), and a context (e.g., a list of top-K documents retrieved from a hybrid search). The assist service system 310c can generate the prompt by aggregating and formatting retrieved data, user input, or system-level instructions into predefined fields of a data object. For example, the assist service system 310c can combine or embed the user query, relevant metadata (e.g., session data or contextual signals), and the top-K results from the hybrid search into a structured prompt format. The AI gateway 340 can receive the prompt and generate a context-aware response by synthesizing the provided data into a coherent and relevant output.

At act 476, the content moderation service 310d can determine the retrieved results or generated response is out of context. For example, the content moderation service 310d can analyze or evaluate the semantic alignment between the user query, system-generated response, and retrieved documents using natural language similarity metrics, embedding comparison techniques, or rule-based context validation. At act 478, in response to determining the results or response is out of context, the first data source 150 can execute a bridge search. For example, the first data source 150 can perform a supplemental search operation or third search to identify related documents or data points that provide missing context or address detected gaps in a hybrid search process (e.g., for any user query, for queries that are out of context, such as questions on changing a password, setting up a payroll account, determining or applying for paid time off (PTO), etc.). At block 480, the bridge search may return a list of links (e.g., set of URLs), and the first data source 150 can transmit a selection of the links (e.g., the top five links) to the assist service system 310c. At block 482, the assist service system 310c can re-rank the results based on the results of the hybrid search process and the results of the bridge search. For example, the assist service system 310c can provide an updated list of selected results (e.g., updated top-K documents) via a prompt to the AI gateway 340.

At act 484, the AI gateway 340 can generate a response. the AI gateway 340 can generate a response by analyzing the prompt received from the assist service system 310c. The AI gateway 340 can integrate the retrieved search results, contextual metadata, and modeled query to formulate the response. For example, the AI gateway 340 can rank or receive a ranking of the retrieved knowledge graph or vector database data, extract or resolve entities, and determine relationships between the entities using one or more large language models or LLMs. Additionally, the AI gateway 340 can map entities in the response back to original sources within the retrieved documents to validate the response or verify accuracy. At act 486, the AI gateway 340 can provide the response to the assist service system 310c. The assist service 310c can store a chat history corresponding to the current chatbot conversation or user query using the history database service 315a at act 488.

Referring now to FIG. 4D, at act 490, the assist service system 310c can transmit a message to the chatbot service 305. The message can include a response to the user query or various header data, body data, or metadata (e.g., a status of “unresolved,” a session ID, etc.). At act 491, the chatbot service 305 can transmit a chatbot message (e.g., response, follow up question, etc.). For example, in response to determining the user query cannot be resolved without additional information, the chatbot interface 115 can display a follow up question prompting a user for clarification or additional input. At act 492, the chatbot interface 115 can transmit a message or request including various fields (e.g., conversation ID, IP address, etc.) or user inputs (e.g., the response to the follow up question, the follow up question, etc.) to the chatbot service 305. The chatbot service 305 can forward the message to the assist service 310c for further processing (e.g., repeating one or more acts of method 400) at act 493.

At act 494, the assist service system 310c can transmit a response to the user query to the chatbot service 305. For example, the response can be updated based on user input received at acts 491-492. In some embodiments, act 494 can include transmitting a response directly to the chatbot upon, responsive to, or subsequent to executing a hybrid search process or bridge search. At act 495, the chatbot service 305 can transmit the response for display via the chatbot interface 115. For example, the chatbot interface 115 can display the generated response as a response to the user query via an output element (e.g., electronic screen or display, speaker, etc.).

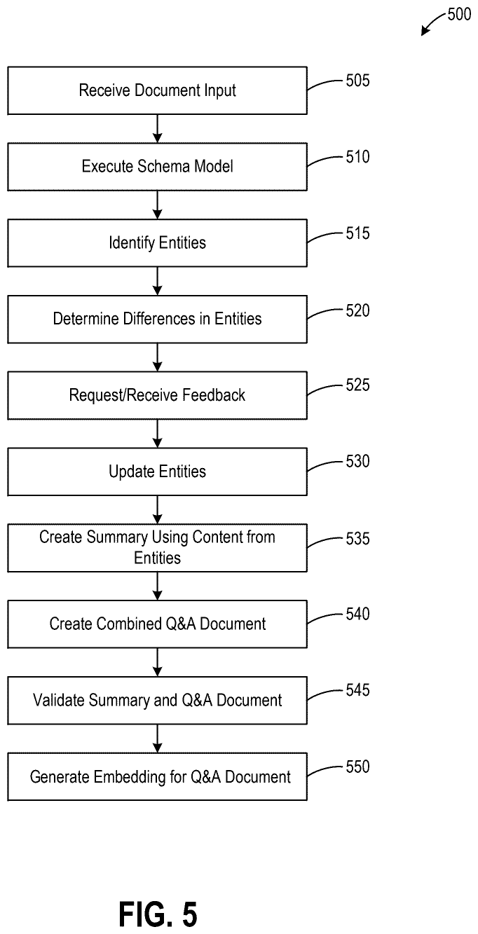

FIG. 5 is an illustrative example of a computer-implemented method 500 for updating data used in a vector-based hybrid search, in accordance with some implementations. In some embodiments, the method 500 can provide content management for one or more data sources by validating or pre-validating data objects or content. For example, the method 500 includes updating first data source 150 with new or additional information that is pre-validated or verified. The method 500 can include acts 505-550. Act 505 can include receiving a document input. For example, the content vetting UI tool can receive a document submission containing header fields, body data, and associated files (e.g., PDF, JSON). The tool can parse the document input to extract relevant structural components, validate the format against predefined specifications, and prepare the content for further processing. The document input can include metadata such as timestamps, user identifiers, or tags for entity extraction and schema validation.

Act 510 can include executing a schema model. A schema model can include or refer to a predefined structure implemented for validating and standardizing document inputs. For example, the schema model can define relationships, constraints, and field requirements or parameters that align with the structure of the document content. The content vetting service can validate incoming data against a schema to detect missing, invalid, or redundant fields. Act 515 can include identifying entities. For example, the content vetting service can analyze document content to extract entities using techniques such as named entity recognition, regex-based matching, or tokenization. For example, extracted entities can include names, numerical values, or relationships encoded within the inputted document. In an example, the vetting service can map extracted entities to predefined categories or hierarchies for integration into a dataset or knowledge base.

Act 520 can include determining differences in entities. For example, the content vetting service can compare the extracted entities against an existing knowledge base or dataset to identify discrepancies. For example, the content vetting service can highlight newly identified entities, update existing relationships, or remove outdated attributes, etc. In an example, the content vetting service can annotate or visualize entity difference in a content vetting user interface (UI) for review and approval. Act 525 can include requesting or receiving feedback. For example, the content vetting UI can prompt subject matter experts (SMEs) to review flagged entities, deltas, or annotations generated during validation or verification. The UI can provide a structured interface that indicates differences between the extracted entities and the existing knowledge base and includes inputs for SME feedback.

Act 530 can include updating entities. For example, a content curation service can process SME feedback to reconcile discrepancies, refine entity attributes, or establish new relationships in a data source or repository. For example, the service can incorporate SME-approved changes by updating entity definitions, modifying associated metadata, or linking entities based on schema-defined relationships. Additionally, the content curation service can validate the updates by applying consistency checks, such as verifying attribute values conform to predefined formats, relationships adhere to schema constraints, and no conflicts exist between updated and existing entities.

Act 535 can include creating a summary using content from the entities. For example, the content curation system can generate a summary that consolidates attributes, relationships, and recent updates to the entities extracted from the documents into a structured format of a concise length. For example, the content curation system can utilize an AI model or large language model to synthesize attributes, relationships, and updates from the entities into a coherent and structured summary. Act 540 can include creating a combined Q&A document. For example, the content curation system can aggregate summaries and entity data into a structured Q&A format that links questions with associated responses. The content curation system can organize the Q&A document by associating frequently asked questions or query templates with relevant attributes or relationships derived from the entities.

Act 545 can include validating the summary and the Q&A document. For example, the content validation service can verify that the generated summary and Q&A document align with the updated entity data, schema rules, or SME feedback received during prior steps. In an example, validation can include confirming that entity attributes, relationships, and metadata are accurately reflected in the documents and confirming that no inconsistencies or missing data exist. Additionally, validation can include performing checks for compliance with predefined formatting or semantic consistency standards and routing or flagging discrepancies for SME review. Act 550 can include generating and storing an embedding for the Q&A document. For example, the embedding generation service can process the Q&A document to create a vector representation that encodes semantic relationships and contextual information within the document. The embedding generation service can store the vector representation in a data source (e.g., first data source) by indexing the embedding with stored vector representations of other stored data objects.

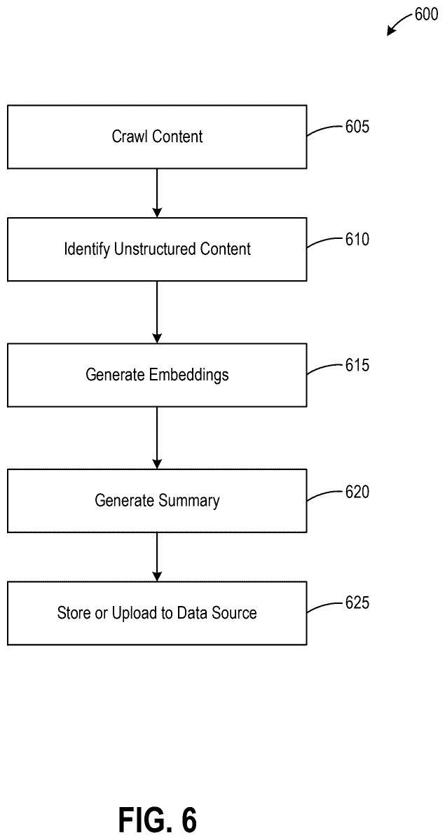

FIG. 6 is an illustrative example of a computer-implemented method 600 for updating data used in a vector-based hybrid search, in accordance with some implementations. In some embodiments, the method 600 includes acts 605-625. In some embodiments, one or more systems or sub-systems described herein (e.g., document generation system 325 of FIG. 3) can perform or execute the method 600. Act 605 can include crawling content. For example, a web crawling module or application can execute one or more programmatic operations to traverse various internal or external data sources, such as internal repositories (e.g., Q&A databases or internal web pages), cloud-based file systems, or external web resources (e.g., websites), to collect and update data used in subsequent search processes. For example, the content crawling service can utilize web scraping techniques, API integrations, or scheduled polling operations to retrieve unstructured or semi-structured content from entity or organizational data (e.g., internal data objects) or third-party data (e.g., external data objects).

Act 610 can include identifying unstructured content. For example, a service or application of document generation system 325 can process the crawled content to identify unstructured elements such as free-form text, tables, images, or other data in non-standardized formats. The service can apply natural language processing (NLP) techniques to detect and extract text, machine learning algorithms to classify content types, or optical character recognition (OCR) to process image-based data. Act 615 can include generating embeddings. For example, the document generation system 325 can interface with an embedding service (e.g., embedding gateway 350, embedding service 320a, etc.) to process the identified unstructured content and create vector embeddings that encode semantic relationships and contextual information. The embeddings can capture or encode features of the content, such as a query subject, similarity patterns or scores, topic distributions, or hierarchical relationships between entities.

Act 620 can include generating a summary. For example, a summarization module or service can analyze embeddings and associated content to generate concise or structured representations of crawled data. Summarization can include extracting attributes, identifying relationships, or determining updates within the crawled content. Summaries can be organized into standardized formats (e.g., JSON, bullet points or paragraphs, etc.) or predefined lengths (e.g., 500 words, etc.) for integration with various data sources. Act 625 can include storing or uploading data to a data source. For example, the updated, validated, or pre-verified embeddings, summaries, or associated metadata can be stored in a vector-based data source (e.g., first data source 150). Storing can include indexing the crawled, summarized, and embedded data in a searchable structure or framework to facilitate subsequent retrieval as search results.

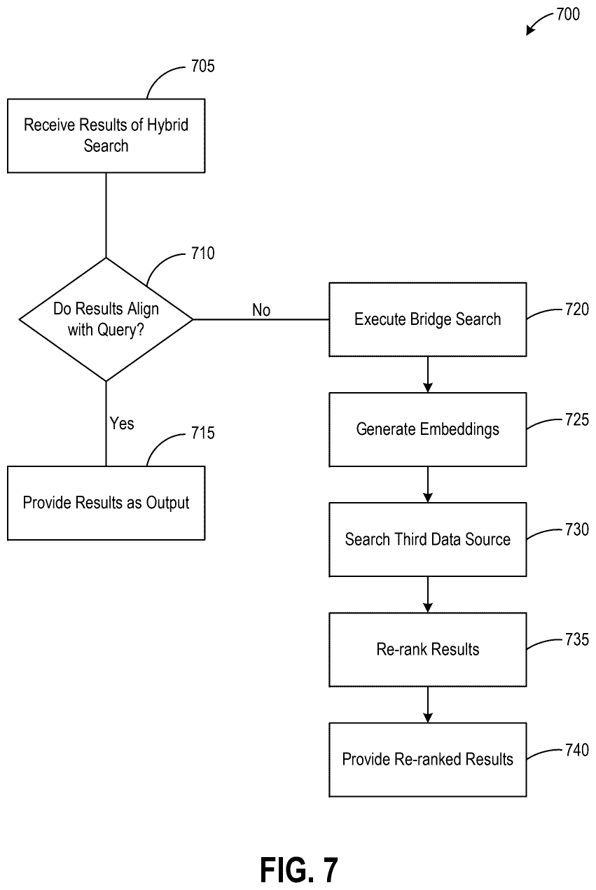

FIG. 7 is an illustrative example of a computer-implemented method 700 for performing a search that can be used in a vector-based hybrid search in accordance with some implementations. In some embodiments, the method 700 can include or refer to a bridge search operation or supplemental search (e.g., a third search). The method 700 can include acts 705-740. Act 705 can include receiving results of a hybrid search. For example, a search orchestration service (e.g., computing system 120, assist service system 310c, etc.) can aggregate results retrieved from multiple sources, including vector-based searches, knowledge graph queries, or keyword searches. The results can include ranked lists of documents, metadata, similarity scores, and contextual indicators corresponding to the user query.

Act 710 can include determining whether the results align with the query. For example, the assist service system 310c can analyze or evaluate the aggregated results by calculating similarity scores between the user query and retrieved results or by assessing metadata relevance. In an example, determining alignment can include analyzing contextual similarities, determining compliance with minimum similarity values, or comparing similarity scores to various thresholds. If the results are determined to align with the user query at act 710, the method 700 can proceed to act 715. Otherwise, the method 700 can continue to act 720. Act 715 can include providing the results as output. For example, the assist service system 310c can prepare aligned results, including ranked documents, metadata, and similarity scores, for output via chatbot interface 115. Act 720 can include executing a bridge search. For example, the assist service system 310c can initiate a supplemental search to refine or expand the query when the initial results fail to meet alignment thresholds. The bridge search may refer to querying a third data source, such as a supplemental database, or performing an additional search of the first data source or second data source to retrieve additional relevant data.

Act 725 can include generating embeddings. For example, the assist service system 310c can use the same search query (e.g., vector representations) in the bridge search, or can refine or expand the original query by generating a new vector representation to address gaps identified in the initial results. Act 730 can include searching within a third data source. For example, the assist service system 310c can query a vector database, an external repository, domain-specific data store, or a knowledge graph using the generated embeddings queries. The bridge search can include execution of various semantic matching operations to compare the query embeddings against indexed vector representations or traversal operations to retrieve relevant nodes and relationships from a knowledge graph. For example, the bridge search can provide supplemental or additional results used to generate a response to the user query.

Act 735 can include re-ranking results. For example, the assist service system 310c can consolidate results from the hybrid search and bridge search into a set for ranking. Re-ranking can include applying scoring algorithms, adjusting weights, determining distances or similarities between vector embeddings, and other operations to prioritize results based on contextual relevance or proximity to the intent or subject of the user query. Act 740 can include providing the re-ranked results. For example, the assist service system 310c can prepare and format the re-ranked results for transmission to the chatbot interface 115. In another example, the assist service system 310c can provide the additional results to an AI model or LLM, which can generate or re-generate a response to the user query based on the query data, hybrid search results, and additional results of the bridge search operation.

FIG. 8 depicts an illustrative architecture of a computing system 800. The block diagram of the example computing system 800 can also be referred to as the computer system 800 or a computing environment 800. Computing system 800 can be used to implement elements of the systems and methods described and illustrated herein, such as, commands, instructions, or data described herein. Computing system 800 can be included in or run any device (e.g., a data processing system, client device 110, computing system 120, embedding system 125, AI model 130, cache search system 135, semantic cache 140, hybrid search system 145, first data source 150, second data source 155, modeling system 160, etc.).

Computing system 800 can include at least one bus data bus 805 or other communication device, structure or component for communicating information or data. Computing system 800 can include at least one processor 810 or processing circuit coupled to the data bus 805 for executing instructions or processing data or information. Computing system 800 can include one or more processors 810 or processing circuits coupled to the data bus 805 for exchanging or processing data or information along with other computing systems 800. Computing system 800 can include one or more main memories 815, such as a random-access memory (RAM), dynamic RAM (DRAM), cache memory, or other dynamic storage device, which can be coupled to the data bus 805 for storing information, data and instructions to be executed by the processor(s) 810. Main memory 815 can be used for storing information (e.g., data, computer code, commands, or instructions) during the execution of instructions by the processor(s) 810.

Computing system 800 can include one or more read only memories (ROMs) 820 or other static storage device 825 coupled to the bus 805 for storing static information and instructions for the processor(s) 810. Storage devices 825 can include any storage device, such as a solid state device, magnetic disk, or optical disk, which can be coupled to the data bus 805 to persistently store information and instructions.

Computing system 800 can be coupled via the data bus 805 to one or more output devices 835, such as speakers or displays (e.g., liquid crystal display or active matrix display) for displaying or providing information to a user. Input devices 830, such as keyboards, touch screens, or voice interfaces, can be coupled to the data bus 805 for communicating information and commands to the processor(s) 810. Input device 830 can include, for example, a touch screen display (e.g., output device 835). Input device 830 can include a cursor control, such as a mouse, a trackball, or cursor direction keys, for communicating direction information and command selections to the processor(s) 810 for controlling cursor movement on a display.

The processes, systems and methods described herein can be implemented by the computing system 800 in response to the processor 810 executing an arrangement of instructions contained in main memory 815. Such instructions can be read into main memory 815 from another non-transitory computer-readable medium (CRM), such as the storage device 825. Execution of the arrangement of instructions stored thereon main memory 815 causes the computing system 800 to perform the illustrative processes described herein. One or more processors 810 in a multi-processing arrangement can also be employed to execute the instructions contained in main memory 815. Hard-wired circuitry can be used in place of or in combination with software instructions together with the systems and methods described herein. Systems and methods described herein are not limited to any specific combination of hardware circuitry and software.

Although an example computing system has been described in FIG. 8, the subject matter including the operations described in this specification can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may or can also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
receive, via a chatbot, a user query;
generate, using an artificial intelligence model, a vector representation based on a combination of the user query, one or more historical queries, and one or more responses corresponding to the one or more historical queries;
identify a cached response corresponding to the user query in a semantic cache by execution of a semantic search operation using the vector representation;
execute, based on the cached response, a hybrid search operation associated with the user query, the hybrid search operation comprising:
retrieval of first results having a first accuracy value by execution of a first search process of the hybrid search operation on a first data source using the vector representation; and
retrieval of second results having a second accuracy value by execution of a second search process of the hybrid search operation on a second data source using data corresponding to the vector representation;
select one of the first results or the second results based on modeling the first accuracy value and the second accuracy value; and
display, responsive to the user query, an output corresponding to the selected one of the first results or the second results.

2. The system of claim 1, wherein the one or more processors further:
generate an index comprising a plurality of vector representations of content based on scanning a plurality of documents;
determine one or more scores representing similarities between the plurality of vector representations of the content and the vector representation; and
provide the first results comprising data of the plurality of documents in response to determining at least one score of the one or more scores satisfies at least one threshold corresponding to the first accuracy value.

3. The system of claim 1, wherein the one or more processors further:
issue one or more automated requests to a plurality of internal sources comprising verified content;
generate a plurality of vector representations corresponding to verified data extracted from the verified content; and
store the plurality of vector representations in an index accessible to the first data source.

4. The system of claim 1, wherein the second data source comprises at least one knowledge graph comprising a plurality of nodes and edges connecting the plurality of nodes, and wherein the data corresponding to the vector representation comprises a structured query corresponding to a schema of the at least one knowledge graph.

5. The system of claim 4, wherein the one or more processors further:
map one or more portions of the vector representation to at least one node type, node attribute, or edge type corresponding to the plurality of nodes and edges based on the schema; and
generate the structured query comprising the at least one node type, node attribute, or edge type.

6. The system of claim 1, wherein the one or more processors further:
identify, using the artificial intelligence model, a subject of the user query corresponding to at least one location;
determine, using the artificial intelligence model, the at least one location corresponds to multiple locations or is incomplete;
disambiguate the at least one location by execution of one or more computer-executable instructions; and
receive, responsive to the disambiguation, a plurality of candidate locations corresponding to the at least one location.

7. The system of claim 6, wherein the one or more processors further:
determine, using the artificial intelligence model, the plurality of candidate locations are dissociated with the subject;
provide, via the chatbot, a prompt comprising one or more location queries corresponding to the at least one location, the multiple locations, or the plurality of candidate locations;
receive, via the chatbot, an input responsive to the prompt; and
update the subject of the user query based on the input.

8. The system of claim 1, wherein the one or more processors further:
determine to execute the hybrid search operation based on determining that the cached response fails to satisfy at least one threshold.

9. The system of claim 1, wherein the one or more processors further:
categorize the user query in a query category based on a predefined taxonomy of query types; and
select search parameters for the hybrid search operation based on the query category.

10. The system of claim 1, wherein the one or more processors further:
aggregate the first results and the second results to generate aggregated results;
rank the aggregated results based on at least one of the first accuracy value, the second accuracy value, or a third accuracy value generated by the artificial intelligence model;
select, using the artificial intelligence model, a subset of the aggregated results satisfying at least one threshold; and
display, using the chatbot, the output comprising the subset in response to the user query.

11. The system of claim 1, wherein the one or more processors further:
determine the first accuracy value and the second accuracy value based on a subject of the user query; and
adjust the first accuracy value or the second accuracy value in response to receiving a new query.

12. The system of claim 11, wherein the one or more processors further:
determine the first results failing the first accuracy value and the second results failing the second accuracy value; and
initiate a third search of one or more third data sources, the one or more third data sources corresponding to a plurality of external links which direct to a plurality of external content.

13. The system of claim 12, wherein the one or more processors further:
retrieve one or more links of the plurality of external links relevant to the user query based on a content relevance score associated with the plurality of external content; and
provide a prompt comprising the one or more links via the chatbot in response to the user query.

14. A method, comprising:
receiving, by one or more processors coupled with memory, via a chatbot, a user query;
generating, by the one or more processors, using an artificial intelligence model, a vector representation based on a combination of the user query, one or more historical queries, and one or more responses corresponding to the one or more historical queries;
identifying, by the one or more processors, a cached response corresponding to the user query in a semantic cache by execution of a semantic search operation using the vector representation;
executing, by the one or more processors, based on the cached response, a hybrid search operation associated with the user query, the hybrid search operation comprises:
retrieving, by the one or more processors, first results having a first accuracy value by execution of a first search process of the hybrid search operation on a first data source using the vector representation; and
retrieving, by the one or more processors, second results having a second accuracy value by execution of a second search process of the hybrid search operation on a second data source using data corresponding to the vector representation;
selecting, by the one or more processors, one of the first results or the second results based on modeling the first accuracy value and the second accuracy value; and
displaying, by the one or more processors, responsive to the user query, an output corresponding to the selected one of the first results or the second results.

15. The method of claim 14, further comprising:
generating, by the one or more processors, an index comprising a plurality of vector representations of content based on scanning a plurality of documents;
determining, by the one or more processors, one or more scores representing similarities between the plurality of vector representations of the content and the vector representation; and
providing, by the one or more processors, the first results comprising data of the plurality of documents in response to determining at least one score of the one or more scores satisfies at least one threshold corresponding to the first accuracy value.

16. The method of claim 14, further comprising:
issuing, by the one or more processors, one or more automated requests to a plurality of internal sources comprising verified content;
generating, by the one or more processors, a second plurality of vector representations corresponding to verified data extracted from the verified content; and
storing, by the one or more processors, the second plurality of vector representations in an index accessible to the first data source.

17. The method of claim 14, wherein the second data source comprises at least one knowledge graph comprising a plurality of nodes and edges connecting the plurality of nodes, and wherein the data corresponding to the vector representation comprises a structured query corresponding to a schema of the at least one knowledge graph.

18. The method of claim 17, further comprising:
mapping, by the one or more processors, one or more portions of the vector representation to at least one node type, node attribute, or edge type corresponding to the plurality of nodes and edges based on the schema; and
generating, by the one or more processors, the structured query comprising the at least one node type, node attribute, or edge type.

19. The method of claim 14, further comprising:
identifying, by the one or more processors, using the artificial intelligence model, a subject of the user query corresponding to at least one location;
determining, by the one or more processors, using the artificial intelligence model, the at least one location corresponds to multiple locations or is incomplete;
disambiguating, by the one or more processors, the at least one location by execution of one or more computer-executable instructions; and
receiving, by the one or more processors, responsive to the disambiguation, a plurality of candidate locations corresponding to the at least one location.

20. A non-transitory computer-readable storage device having instructions stored thereon on that, when executed by one or more processors, cause the one or more processors to:
receive, via a chatbot, a user query;
generate, using an artificial intelligence model, a vector representation based on a combination of the user query, one or more historical queries, and one or more responses corresponding to the one or more historical queries;
identify a cached response corresponding to the user query in a semantic cache by execution of a semantic search operation using the vector representation;
execute, based on the cached response, a hybrid search operation associated with the user query, the hybrid search operation comprises:
retrieval of first results having a first accuracy value by execution of a first search process of the hybrid search operation on a first data source using the vector representation; and
retrieval of second results having a second accuracy value by execution of a second search process of the hybrid search operation on a second data source using data corresponding to the vector representation;
select one of the first results or the second results based on modeling the first accuracy value and the second accuracy value; and
display, responsive to the user query, an output corresponding to the selected one of the first results or the second results.
